(19) United States
(12) Patent Application Publication
(10) Pub. No.: US 2012/0133676 A1
(43) Pub. Date: May 31, 2012

(54) STORAGE MEDIUM HAVING STORED THEREON IMAGE PROCESSING PROGRAM, IMAGE PROCESSING APPARATUS, IMAGE PROCESSING SYSTEM, AND IMAGE PROCESSING METHOD

(75) Inventor: Shinji KITAHARA, Kyoto (JP)

(73) Assignee: NINTENDO CO., LTD., Kyoto (JP)

(21) Appl. No.: 13/197,231

(22) Filed: Aug. 3, 2011

(30) Foreign Application Priority Data
Nov. 30, 2010 (JP) 2010-266873

(51) Int. Cl. G09G 5/00

(52) U.S. Cl. 345/633

(57) ABSTRACT

At least one virtual object for which a predetermined color is set is placed in a virtual world. In a captured image captured by a real camera, at least one pixel corresponding to the predetermined color is detected, using color information including at least one selected from the group including RGB values, a hue, a saturation, and a brightness of each pixel of the captured image. When the pixel corresponding to the predetermined color has been detected, a predetermined process is performed on the virtual object for which the predetermined color is set. An image of the virtual world where at least the virtual object is placed is displayed on a display device.

### CROSS REFERENCE TO RELATED APPLICATION

The disclosure of Japanese Patent Application No. 2010-266873, filed on Nov. 30, 2010, is incorporated herein by reference.

### BACKGROUND OF THE INVENTION

1. Field of the Invention

The present invention relates to a storage medium having stored thereon an image processing program, an image processing apparatus, an image processing system, and an image processing method, and in particular, relates to a storage medium having stored thereon an image processing program that performs a predetermined process on a virtual object, using a real world image, and an image processing apparatus, an image processing system, and an image processing method that perform a predetermined process on a virtual object, using a real world image.

2. Description of the Background Art

Conventionally, as disclosed in, for example, Japanese Laid-Open Patent Publication No. 2008-113746 (hereinafter referred to as “Patent Literature 1”), a proposal is made for an apparatus that displays an image obtained by overlapping a real world image and a virtual world image. A game apparatus disclosed in Patent Literature 1 displays an image, captured by an outer camera, as a background image so as to overlap a game image. Specifically, the game apparatus updates the background image at regular time intervals, and displays the most recent background image so as to overlap the game image.

The game apparatus disclosed in Patent Literature 1, however, merely displays the image captured by the outer camera as the background image. In this case, the overlapping background image and game image are displayed in the state where they are not related to each other at all. Thus, the displayed image per se is monotonous, and therefore, it is not possible to present an interesting image to a user.

### SUMMARY OF THE INVENTION

Therefore, it is an object of the present invention to provide a storage medium having stored thereon an image processing program capable of performing a new process on a virtual object, using a real world image, and an image processing apparatus, an image processing system, and an image processing method that are capable of performing a new process on a virtual object, using a real world image.

To achieve the above object, the present invention may employ, for example, the following configurations. It is understood that when the description of the scope of the appended claims is interpreted, the scope should be interpreted only by the description of the scope of the appended claims. If the description of the scope of the appended claims contradicts the description of these columns, the description of the scope of the appended claims has priority.

An example of the configuration of a computer-readable storage medium having stored thereon the image processing program according to the present invention is executed by a computer of an image processing apparatus that processes an image to be displayed on a display device. The image processing program causes the computer to function as captured image acquisition means, object placement means, color detection means, object process means, and image display control means. The captured image acquisition means acquires a captured image captured by a real camera. The object placement means places in a virtual world at least one virtual object for which a predetermined color is set. The color detection means, in the captured image acquired by the captured image acquisition means, detects at least one pixel corresponding to the predetermined color set for the virtual object placed in the virtual world, using color information including at least one selected from the group including RGB values, a hue, a saturation, and a brightness of each pixel of the captured image. The object process means, when the color detection means has detected the pixel corresponding to the predetermined color, performs a predetermined process on the virtual object for which the predetermined color is set. The image display control means displays on the display device an image of the virtual world where at least the virtual object is placed.

Based on the above, when a pixel corresponding to a predetermined color of a virtual object is included in a real world image, a predetermined process is performed on the virtual object. This makes it possible to perform a new process on the virtual object, using the real world image.

In addition, the image processing program may further cause the computer to function as image combination means. The image combination means generates a combined image obtained by combining the captured image acquired by the captured image acquisition means with the image of the virtual world where the virtual object is placed. In this case, the image display control means may display the combined image generated by the image combination means on the display device.

Based on the above, display is performed such that a captured image (the real world image) and an image in which the virtual object is placed (a virtual world image) are combined together. This makes it possible to present a more interesting image.

In addition, when the image combination means combines the captured image with the image of the virtual world, the object process means may perform the predetermined process on, among the virtual objects for which the predetermined color is set, a virtual object that overlaps the pixel corresponding to the predetermined color when combined with the captured image.

Based on the above, a virtual object corresponding to the position of a subject corresponding to the predetermined color detected in the captured image is subject to the predetermined process. This requires a user to perform an operation of overlapping a virtual object on which the user wishes to perform the predetermined process and a specific-colored subject, and this makes it possible to provide a new operation environment.

In addition, the object placement means may place in the virtual world a plurality of virtual objects for which the predetermined color is set. The object process means may perform the predetermined process on, among the plurality of virtual objects for which the predetermined color is set, all the virtual objects that, when combined with the captured image, overlap pixels corresponding to a predetermined color that is the same as the predetermined color.

Based on the above, a plurality of virtual objects corresponding to the position of a subject corresponding to the predetermined color detected in the captured image can be subject to the predetermined process. Thus, when a user wishes to perform the predetermined process on the plurality of virtual objects, the user needs to perform an operation of simultaneously overlapping the plurality of virtual objects and a specific-colored subject. This makes it possible to provide a new operation environment.

In addition, the image processing program may further cause the computer to function as operation signal acquisition means. The operation signal acquisition means acquires an operation signal in accordance with an operation of a user. In this ease, when the color detection means has detected the pixel corresponding to the predetermined color and the operation signal acquisition means has acquired an operation signal indicating an operation of making an attack on a virtual object, the object process means may make a predetermined attack on the virtual object for which the predetermined color is set.

Based on the above, when the pixel corresponding to the predetermined color set for the virtual object is included in the captured image, it is possible to perform an attack operation such that the virtual object serves as a target of attack. Therefore, to attack the virtual object, a user needs to perform the attack operation while adjusting the capturing direction of a real camera so that a subject corresponding to the predetermined color of the virtual object is included in the camera image. This makes it possible to provide a game of performing a new process on the virtual object, using the real world image.

In addition, when the color detection means has detected the pixel corresponding to the predetermined color, the object process means may set a predetermined sign for the virtual object for which the predetermined color is set. The image display control means may assign the sign set by the object process means to the virtual object, and may display on the display device an image of the virtual world where the virtual object to which the sign is assigned is placed.

Based on the above, the display of a sign makes it possible to distinguish the virtual object subject to the predetermined process.

In addition, the object process means may cause the virtual object on which the predetermined attack has been made, to disappear from the virtual world.

Based on the above, a predetermined attack operation of the user makes it possible to cause the virtual object serving as a target of attack to disappear.

In addition, the color detection means may detect, as the pixel corresponding to the predetermined color, a pixel having items of the color information indicating the saturation and the brightness that are equal to or greater than predetermined thresholds, respectively, and also having an item of the color information indicating the hue indicative of a value within a predetermined range.

Based on the above, the detection of the pixel corresponding to the predetermined color by combining a plurality of items of color information makes it possible to bring the image processing result close to the color recognition normally performed by a user, while preventing erroneous color determinations.

In addition, a display color of the virtual object for which the predetermined color is set may be set to substantially the same color as the predetermined color. The image display control means may display on the display device the virtual object for which the predetermined color is set, such that the set display color is included at least in part of an image representing the virtual object.

Based on the above, a display color of the displayed virtual object enables a user to understand the color of a subject on the basis of which the predetermined process is performed.

In addition, a display color of the virtual object for which the predetermined color is set may be set to a substantially complementary color of the predetermined color. The image display control means may display on the display device the virtual object for which the predetermined color is set, such that the set display color is included at least in part of an image representing the virtual object.

Based on the above, a display color of the displayed virtual object enables a user to understand the color of a subject on the basis of which the predetermined process is performed. Further, the complementary color of the display color of the virtual object serves as the color of the subject on the basis of which the predetermined process is performed on the virtual object. This makes it possible to cause the user to take into account the relationship of the complementary color.

In addition, the color detection means may include block division means and block ROB average value calculation means. The block division means divides the captured image into blocks each including a plurality of pixels. The block RGB average value calculation means calculates average values of ROB values of pixels included in each block. In this case, the color detection means may detect, in the captured image, pixels corresponding to the predetermined color, on the basis of the average values of each block such that the block is a detection unit.

Based on the above, the determination of color information on a block-by-block basis facilitates a color detection process, and therefore reduces the processing load.

In addition, the captured image acquisition means may repeatedly acquire captured images of a real world captured in real time by a real camera available to the image processing apparatus. The color detection means may repeatedly detect pixels corresponding to the predetermined color in the captured images, respectively, repeatedly acquired by the captured image acquisition means. The object process means may repeatedly perform the predetermined process on the virtual object on the basis of results of the repeated detections of the color detection means. The image combination means may repeatedly generate combined images by combining each of the captured images repeatedly acquired by the captured image acquisition means, with the image of the virtual world where the virtual object is placed. The image display control means may repeatedly display on the display device the combined images obtained by combining each of the captured images repeatedly acquired by the captured image acquisition means, with the image of the virtual world.

Based on the above, it is possible to perform a new process on the virtual object, using a moving image of the real world captured in real time.

In addition, the image processing program may further cause the computer to function as color setting means. The color setting means, after the object process means has performed the predetermined process on the virtual object, changes the predetermined color of the virtual object to a different color.

Based on the above, to further perform the predetermined process on the virtual object, it is necessary to further capture a subject having a different specific color. This increases the level of difficulty of the operation to be performed by a user, and this makes it possible to provide a new operation environment.

In addition, the image processing program may further cause the computer to function as process setting means. The process setting means, when the color detection means has detected the pixel corresponding to the predetermined color, changes a content of the predetermined process to be performed on the virtual object for which the predetermined color is set, on the basis of the color information of the pixel.

Based on the above, on the basis of color information of a pixel corresponding to the predetermined color of the virtual object, the content of the predetermined process to be performed on the virtual object is changed. This requires a user to further limit the color of a subject in order to perform a desired process on the virtual object, and this makes it possible to further increase the level of difficulty of the operation.

In addition, the present invention may be carried out in the form of an image processing apparatus and an image processing system that include the above means, and may be carried out in the form of an image processing method including operations performed by the above means.

Based on the present invention, when a pixel corresponding to a predetermined color of a virtual object is included in a real world image, a predetermined process is performed on the virtual object. This makes it possible to perform a new process on the virtual object, using the real world image.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a front view showing an example of a game apparatus 10 being open;

FIG. 2 is a right side view showing an example of the game apparatus 10 being open;

FIG. 3A is a left side view showing an example of the game apparatus 10 being closed;

FIG. 3B is a front view showing an example of the game apparatus 10 being closed;

FIG. 3C is a right side view showing an example of the game apparatus 10 being closed;

FIG. 3D is a rear view showing an example of the game apparatus 10 being closed;

FIG. 4 is a diagram showing an example of a user holding the game apparatus 10 with both hands;

FIG. 5 is a block diagram showing an example of the internal configuration of the game apparatus 10;

FIG. 6 is a diagram showing an example where display is performed on an upper LCD 22 such that a camera image CI and a plurality of virtual objects are combined together;

FIG. 7 is a diagram showing an example where display is performed on the upper LCD 22 such that a red subject included in the camera image CI and some of the plurality of virtual objects are displayed so as to overlap each other;

FIG. 8 is a diagram showing an example of an image displayed on the upper LCD 22 when a user has performed an attack operation in the state shown in FIG. 7;

FIG. 9 is a diagram showing an example of various data stored in a main memory 32 in accordance with the execution of an image processing program;

FIG. 10 is a diagram showing an example of block data Dc of FIG. 9;

FIG. 11 is a diagram showing an example of object data Dd of FIG. 9;

FIG. 12 is a flow chart showing an example of the operation of image processing performed by the game apparatus 10 in accordance with the execution of the image processing program;

FIG. 13 is a subroutine flow chart showing an example of a detailed operation of an object setting process performed in step 54 of FIG. 12; and

FIG. 14 is a subroutine flow chart showing an example of a detailed operation of a color detection process performed in step 61 of FIG. 13.

### DESCRIPTION OF THE PREFERRED EMBODIMENTS

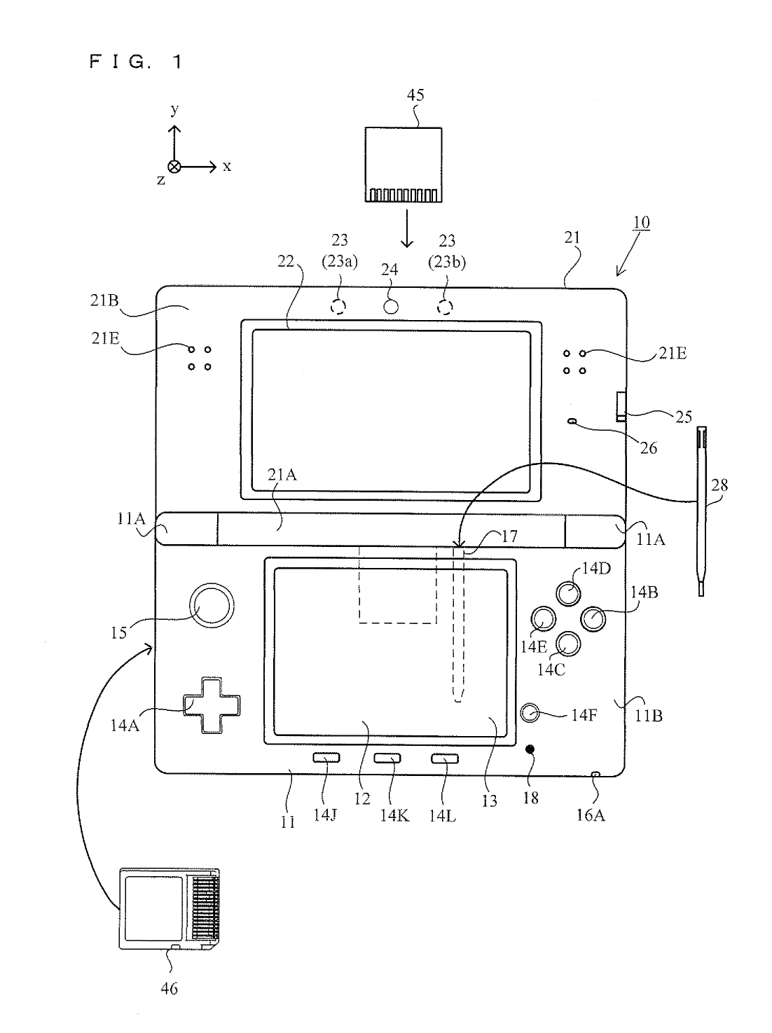

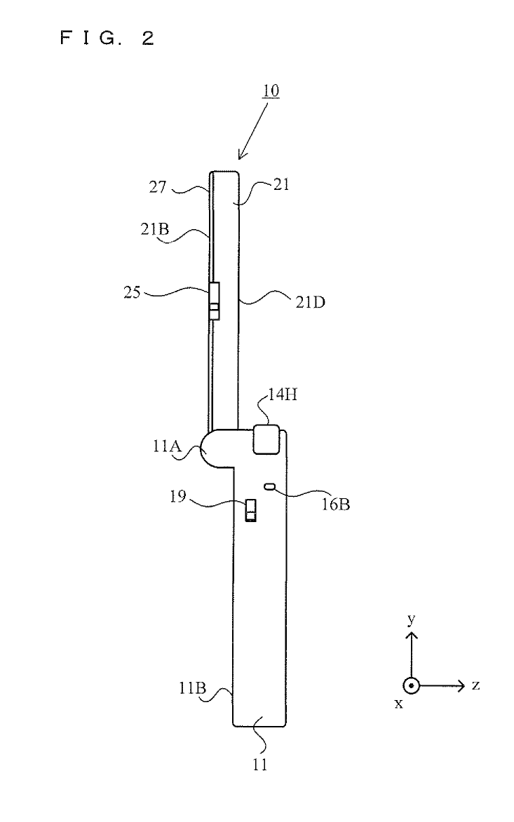

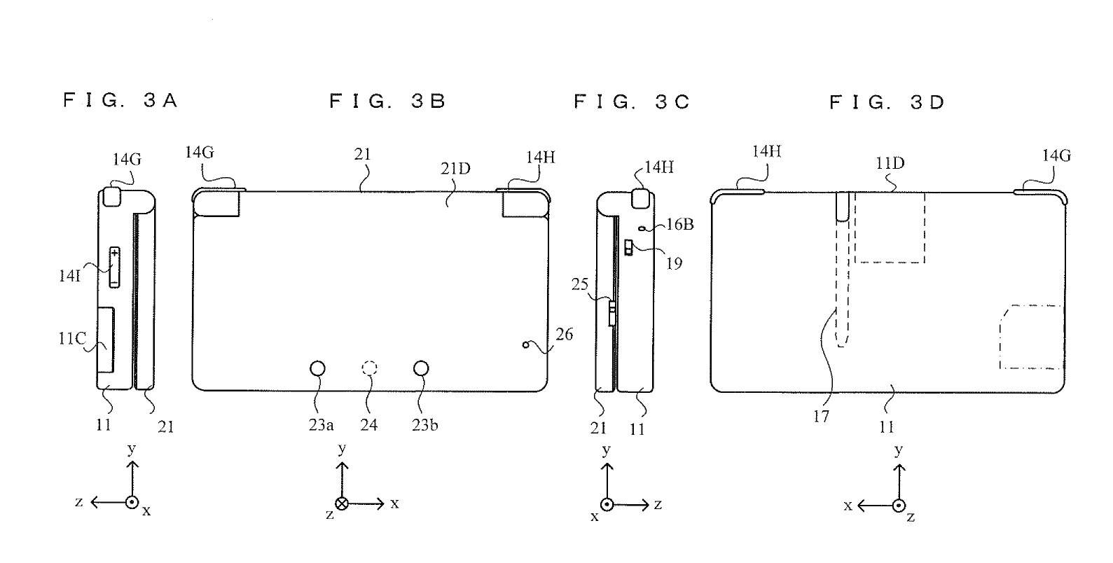

With reference to the drawings, a description is given of an image processing apparatus that executes an image processing program according to an embodiment of the present invention. The image processing program according to the present invention can be applied by being executed by a given computer system. As an example of the image processing apparatus, a hand-held game apparatus 10 is taken, and the description is given using the image processing program executed by the game apparatus 10. It should be noted that FIGS. 1 through 3D are each a plan view showing an example of the outer appearance of the game apparatus 10. As an example, the game apparatus 10 is a hand-held game apparatus, and is configured to be foldable as shown in FIGS. 1 through 3D. FIG. 1 is a front view showing an example of the game apparatus 10 being open (in an open state). FIG. 2 is a right side view showing an example of the game apparatus 10 in the open state. FIG. 3A is a left side view showing an example of the game apparatus 10 being closed (in a closed state). FIG. 3B is a front view showing an example of the game apparatus 10 in the closed state. FIG. 3C is a right side view showing an example of the game apparatus 10 in the closed state. FIG. 3D is a rear view showing an example of the game apparatus 10 in the closed state. The game apparatus 10 includes capturing sections, and is capable, for example, of capturing an image with the capturing sections, displaying the captured image on a screen, and storing data of the captured image. The game apparatus 10 is capable of executing a game program stored in an exchangeable memory card, or received from a server or another game apparatus, and is also capable of displaying on the screen an image generated by computer graphics processing, such as a virtual world image viewed from by a virtual camera set in a virtual space.

In FIGS. 1 through 3D, the game apparatus 10 includes a lower housing 11 and an upper housing 21. The lower housing 11 and the upper housing 21 are joined together so as to be openable and closable in a folding manner (foldable). In the example of FIG. 1, the lower housing 11 and the upper housing 21 each have a wider-than-high rectangular plate-like shape, and are joined together at one of the long sides of the lower housing 11 and the corresponding one of the long sides of the upper housing 21 so as to be pivotable relative to each other. Normally, a user uses the game apparatus 10 in the open state. The user stores away the game apparatus 10 in the closed state when not using it. Further, as well as the closed state and the open state that are described above, the game apparatus 10 can maintain the lower housing 11 and the upper housing 21 at a given angle formed between the game apparatus 10 in the closed state and the game apparatus 10 in the open state due, for example, to a frictional force generated at the connecting part. That is, the upper housing 21 can be maintained stationary at a given angle with respect to the lower housing 11.

As shown in FIGS. 1 and 2, projections 11A are provided at the upper long side portion of the lower housing 11, the projections 11A projecting perpendicularly to an inner surface (main surface) 11B of the lower housing 11. A projection 21A is provided at the lower long side portion of the upper housing 21, the projection 21A projecting perpendicularly to the lower side surface of the upper housing 21 from the lower side surface of the upper housing 21. The joining of the projections 11A of the lower housing 11 and the projection 21A of the upper housing 21 connects the lower housing 11 and the upper housing 21 together in a foldable manner.

The lower housing 11 includes a lower liquid crystal display (LCD) 12, a touch panel 13, operation buttons 14A through 14L (FIG. 1, FIGS. 3A through 3D), an analog stick 15, LEDs 16A and 16B, an insertion slot 17, and a microphone hole 18. These components are described in detail below.

As shown in FIG. 1, the lower LCD 12 is accommodated in the lower housing 11. The lower LCD 12 has a wider-than-high shape, and is placed such that the long side direction of the lower LCD 12 coincides with the long side direction of the lower housing 11. The lower LCD 12 is placed at the center of the lower housing 11. The lower LCD 12 is provided on the inner surface (main surface) of the lower housing 11, and the screen of the lower LCD 12 is exposed through an opening provided in the inner surface of the lower housing 11. The game apparatus 10 is in the closed state when not used, so that the screen of the lower LCD 12 is prevented from being soiled or damaged. As an example, the number of pixels of the lower LCD 12 is 256 dots×192 dots (horizontal×vertical). As another example, the number of pixels of the lower LCD 12 is 320 dots×240 dots (horizontal×vertical). Unlike the upper LCD 22 described later, the lower LCD 12 is a display device that displays an image in a planar manner (not in a stereoscopically visible manner). It should be noted that although an LCD is used as a display device in the present embodiment, another given display device may be used, such as a display device using electroluminescence (EL). Further, a display device having a given resolution may be used as the lower LCD 12.

As shown in FIG. 1, the game apparatus 10 includes the touch panel 13 as an input device. The touch panel 13 is mounted so as to cover the screen of the lower LCD 12. In the present embodiment, the touch panel 13 may be, but is not limited to, a resistive touch panel. The touch panel may also be a touch panel of any pressure type, such as an electrostatic capacitance type. In the present embodiment, the touch panel 13 has the same resolution (detection accuracy) as that of the lower LCD 12. The resolutions of the touch panel 13 and the lower LCD 12, however, may not necessarily need to coincide with each other. Further, the insertion slot 17 (a dashed line shown in FIGS. 1 and 3D) is provided on the upper side surface of the lower housing 11. The insertion slot 17 can accommodate a stylus 28 that is used to perform an operation on the touch panel 13. Although an input on the touch panel 13 is normally provided using the stylus 28, an input may be provided on the touch panel 13 not only by the stylus 28 but also by a finger of the user.

The operation buttons 14A through 14L are each an input device for providing a predetermined input. As shown in FIG. 1, among the operation buttons 14A through 14L, the cross button 14A (direction input button 14A), the operation button 14B, the operation button 14C, the operation button 14D, the operation button 14E, the power button 14F, the select button 14J, the home button 14K, and the start button 14L are provided on the inner surface (main surface) of the lower housing 11. The cross button 14A is cross-shaped, and includes operation buttons for indicating up, down, left, and right directions, respectively. The operation button 14B, the operation button 14C, the operation button 14D, and the operation button 14E are placed in a cross formation. The operation buttons 14A through 14E, the select button 14J, the home button 14K, and the start button 14L are appropriately assigned functions, respectively, in accordance with the program executed by the game apparatus 10. The cross button 14A is used for, for example, a selection operation. The operation buttons 14B through 14E are used for, for example, a determination operation or a cancellation operation. The power button 14F is used to power on/off the game apparatus 10.

The analog stick 15 is a device for indicating a direction, and is provided in the upper left region of the lower LCD 12 of the inner surface of the lower housing 11. As shown in FIG. 1, the cross button 14A is provided in the lower left region of the lower LCD 12 of the lower housing 11 such that the analog stick 15 is provided above the cross button 14A. The analog stick 15 and the cross button 14A are placed so as to be operated by the thumb of a left hand holding the lower housing 11. Further, the provision of the analog stick 15 in the upper region places the analog stick 15 at the position where the thumb of a left hand holding the lower housing 11 is naturally placed, and also places the cross button 14A at the position where the thumb of the left hand is moved slightly downward from the analog stick 15. The key top of the analog stick 15 is configured to slide parallel to the inner surface of the lower housing 11. The analog stick 15 functions in accordance with the program executed by the game apparatus 10. It should be noted that the analog stick 15 may be a component capable of providing an analog input by being tilted by a predetermined amount in any one of up, down, right, left, and diagonal directions.

The four operation buttons placed in a cross formation, namely, the operation button 14B, the operation button 14C, the operation button 14D, and the operation button 14E, are placed at the positions where the thumb of a right hand holding the lower housing 11 is naturally placed. Further, these four operation buttons and the analog stick 15 are placed symmetrically to each other with respect to the lower LCD 12. This also enables, for example, a left-handed person to provide a direction indication input using these four operation buttons, depending on the game program.

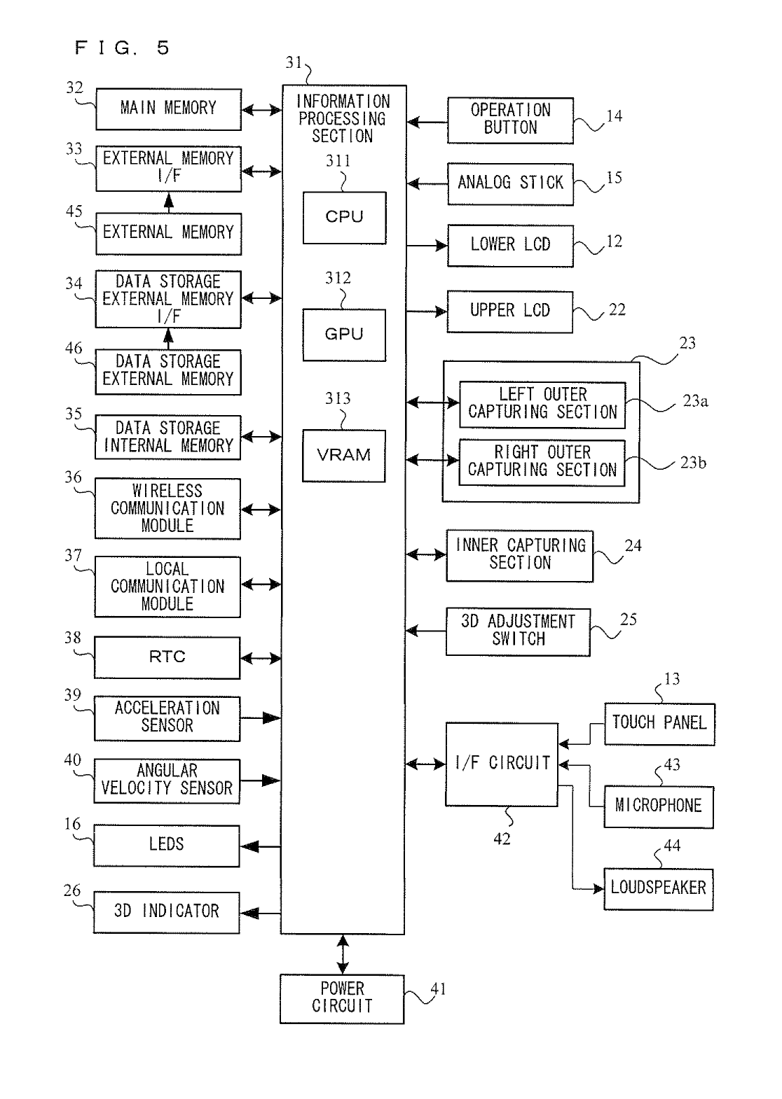

Further, the microphone hole 18 is provided on the inner surface of the lower housing 11. Underneath the microphone hole 18, a microphone (see FIG. 5) is provided as the sound input device described later, and detects sound from outside the game apparatus 10.

As shown in FIGS. 3B and 3D, the L button 14G and the R button 14H are provided on the upper side surface of the lower housing 11. The L button 14G is provided at the left end portion of the upper side surface of the lower housing 11, and the R button 14H is provided at the right end portion of the upper side surface of the lower housing 11. As described later, the L button 14G and the R button 14H function as shutter buttons (capturing instruction buttons) of the capturing sections. Further, as shown in FIG. 3A, the sound volume button 14I is provided on the left side surface of the lower housing 11. The sound volume button 14I is used to adjust the sound volume of a loudspeaker of the game apparatus 10.

As shown in FIG. 3A, a cover section 11C is provided on the left side surface of the lower housing 11 so as to be openable and closable. Within the cover section 11C, a connector (not shown) is provided for electrically connecting the game apparatus 10 and a data storage external memory 46 together. The data storage external memory 46 is detachably attached to the connector. The data storage external memory 46 is used to, for example, record (store) data of an image captured by the game apparatus 10. It should be noted that the connector and the cover section 11C may be provided on the right side surface of the lower housing 11.

As shown in FIG. 3D, on the upper side surface of the lower housing 11, an insertion slot 11D is provided, into which an external memory 45 having a game program stored thereon is to be inserted. Within the insertion slot 11D, a connector (not shown) is provided for electrically connecting the game apparatus 10 and the external memory 45 together in a detachable manner. A predetermined game program is executed by connecting the external memory 45 to the game apparatus 10. It should be noted that the connector and the insertion slot 11D may be provided on another side surface (e.g., the right side surface) of the lower housing 11.

As shown in FIG. 1, on the lower side surface of the lower housing 11, the first LED 16A is provided for notifying the user of the on/off state of the power supply of the game apparatus 10. Further, as shown in FIG. 3C, on the right side surface of the lower housing 11, the second LED 16B is provided for notifying the user of the establishment state of the wireless communication of the game apparatus 10. Furthermore, the game apparatus 10 is capable of wirelessly communicating with other devices, and the second LED 16B is lit on when wireless communication is established between the game apparatus 10 and other devices. The game apparatus 10 has the function of establishing connection with a wireless LAN by, for example, a method based on the IEEE 802.11.b/g standard. On the right side surface of the lower housing 11, a wireless switch 19 is provided for enabling/disabling the function of the wireless communication (see FIG. 3C).

It should be noted that although not shown in the figures, a rechargeable battery that serves as the power supply of the game apparatus 10 is accommodated in the lower housing 11, and the battery can be charged through a terminal provided on the side surface (e.g., the upper side surface) of the lower housing 11.

The upper housing 21 includes an upper LCD 22, an outer capturing section 23 having two outer capturing sections (a left outer capturing section 23a and a right outer capturing section 23b), an inner capturing section 24, a 3D adjustment switch 25, and a 3D indicator 26. These components are described in detail below.

As shown in FIG. 1, the upper LCD 22 is accommodated in the upper housing 21. The upper LCD 22 has a wider-than-high shape, and is placed such that the long side direction of the upper LCD 22 coincides with the long side direction of the upper housing 21. The upper LCD 22 is placed at the center of the upper housing 21. As an example, the area of the screen of the upper LCD 22 is set greater than that of the lower LCD 12. Specifically, the screen of the upper LCD 22 is set horizontally longer than the screen of the lower LCD 12. That is, the proportion of the width in the aspect ratio of the screen of the upper LCD 22 is set greater than that of the lower LCD 12.

The screen of the upper LCD 22 is provided on the inner surface (main surface) 21B of the upper housing 21, and is exposed through an opening provided in the inner surface of the upper housing 21. Further, as shown in FIG. 2, the inner surface of the upper housing 21 is covered by a transparent screen cover 27. The screen cover 27 protects the screen of the upper LCD 22, and integrates the upper LCD 22 and the inner surface of the upper housing 21, and thereby provides unity. As an example, the number of pixels of the upper LCD 22 is 640 dots×200 dots (horizontal×vertical). As another example, the number of pixels of the upper LCD 22 is 800 dots×240 dots (horizontal×vertical). It should be noted that although an LCD is used as the upper LCD 22 in the present embodiment, a display device using EL or the like may be used. Furthermore, a display device having a given resolution may be used as the upper LCD 22.

The upper LCD 22 is a display device capable of displaying a stereoscopically visible image. The upper LCD 22 is capable of displaying a left-eye image and a right-eye image, using substantially the same display region. Specifically, the upper LCD 22 is a display device using a method in which the left-eye image and the right-eye image are displayed alternately in the horizontal direction in predetermined units (e.g., in every other line). As an example, if the number of pixels of the upper LCD 22 is 800 dots×240 dots, the horizontal 800 pixels may be alternately assigned to the left-eye image and the right-eye image such that each image is assigned 400 pixels, whereby the resulting image is stereoscopically visible. It should be noted that the upper LCD 22 may be a display device using a method in which the left-eye image and the right-eye image are displayed alternately for a predetermined time. Further, the upper LCD 22 is a display device capable of displaying an image stereoscopically visible with the naked eye. In this case, a lenticular type display device or a parallax barrier type display device is used so that the left-eye image and the right-eye image that are displayed alternately in the horizontal direction can be viewed separately with the left eye and the right eye, respectively. In the present embodiment, the upper LCD 22 is of a parallax barrier type. The upper LCD 22 displays an image stereoscopically visible with the naked eye (a stereoscopic image), using the right-eye image and the left-eye image. That is, the upper LCD 22 allows the user to view the left-eye image with their left eye, and the right-eye image with their right eye, using the parallax barrier. This makes it possible to display a stereoscopic image giving the user a stereoscopic effect (a stereoscopically visible image). Furthermore, the upper LCD 22 is capable of disabling the parallax barrier. When disabling the parallax barrier, the upper LCD 22 is capable of displaying an image in a planar manner (the upper LCD 22 is capable of displaying a planar view image, as opposed to the stereoscopically visible image described above. This is a display mode in which the same displayed image can be viewed with both the left and right eyes.). Thus, the upper LCD 22 is a display device capable of switching between: the stereoscopic display mode for displaying a stereoscopically visible image; and the planar display mode for displaying an image in a planar manner (displaying a planar view image). The switching of the display modes is performed by the 3D adjustment switch 25 described later.

The “outer capturing section 23” is the collective term of the two capturing sections (the left outer capturing section 23a and the right outer capturing section 23b) provided on an outer surface (the back surface, which is the opposite side to the main surface including the upper LCD 22) 21D of the upper housing 21. The capturing directions of the left outer capturing section 23a and the right outer capturing section 23b are each the same as the outward normal direction of the outer surface 21D. Further, the left outer capturing section 23a and the right outer capturing section 23b are each designed so as to be placed 180 degrees opposite to the normal direction of the display surface (inner surface) of the upper LCD 22. That is, the capturing direction of the left outer capturing section 23a and the capturing direction of the right outer capturing section 23b are parallel to each other. The left outer capturing section 23a and the right outer capturing section 23b can be used as a stereo camera, depending on the program executed by the game apparatus 10. Alternatively, either one of the two outer capturing sections (the left outer capturing section 23a and the right outer capturing section 23b) may be used solely, so that the outer capturing section 23 can also be used as a non-stereo camera, depending on the program. Yet alternatively, depending on the program, images captured by the two outer capturing sections (the left outer capturing section 23a and the right outer capturing section 23b) may be combined together, or may be used to compensate for each other, so that capturing can be performed with an extended capturing range. In the present embodiment, the outer capturing section 23 includes two capturing sections, namely, the left outer capturing section 23a and the right outer capturing section 23b. The left outer capturing section 23a and the right outer capturing section 23b each include an imaging device (e.g., a CCD image sensor or a CMOS image sensor) having a predetermined common resolution, and a lens. The lens may have a zoom mechanism.

As indicated by dashed lines in FIG. 1 and solid lines in FIG. 3B, the left outer capturing section 23a and the right outer capturing section 23b included in the outer capturing section 23 are placed parallel to the horizontal direction of the screen of the upper LCD 22. That is, the left outer capturing section 23a and the right outer capturing section 23b are placed such that a straight line connecting between the left outer capturing section 23a and the right outer capturing section 23b is parallel to the horizontal direction of the screen of the upper LCD 22. The dashed lines 23a and 23b in FIG. 1 indicate the left outer capturing section 23a and the right outer capturing section 23b, respectively, provided on the outer surface, which is the opposite side of the inner surface of the upper housing 21. As shown in FIG. 1, when the user views the screen of the upper LCD 22 from the front thereof, the left outer capturing section 23a is placed to the left of the upper LCD 22, and the right outer capturing section 23b is placed to the right of the upper LCD 22. When a program is executed that causes the outer capturing section 23 to function as a stereo camera, the left outer capturing section 23a captures a left-eye image, which is to be viewed with the user's left eye, and the right outer capturing section 23b captures a right-eye image, which is to be viewed with the user's right eye. The distance between the left outer capturing section 23a and the right outer capturing section 23b is set to correspond to the distance between both eyes of a person, and may be set, for example, in the range of from 30 mm to 70 mm. The distance between the left outer capturing section 23a and the right outer capturing section 23b, however, is not limited to this range.

It should be noted that in the present embodiment, the left outer capturing section 23a and the right outer capturing section 23b are fixed to the housing, and therefore, the capturing directions cannot be changed.

The left outer capturing section 23a and the right outer capturing section 23b are placed symmetrically to each other with respect to the center of the upper LCD 22 (the upper housing 21) in the left-right direction. That is, the left outer capturing section 23a and the right outer capturing section 23b are placed symmetrically with respect to the line dividing the upper LCD 22 into two equal left and right parts. Further, the left outer capturing section 23a and the right outer capturing section 23b are placed in the upper portion of the upper housing 21 and in the back of the portion above the upper end of the screen of the upper LCD 22, in the state where the upper housing 21 is in the open state. That is, the left outer capturing section 23a and the right outer capturing section 23b are placed on the outer surface of the upper housing 21, and, if the upper LCD 22 is projected onto the outer surface of the upper housing 21, is placed above the upper end of the screen of the projected upper LCD 22. Thus, the two capturing sections (the left outer capturing section 23a and the right outer capturing section 23b) of the outer capturing section 23 are placed symmetrically with respect to the center of the upper LCD 22 in the left-right direction. This makes it possible that when the user views the upper LCD 22 from the front thereof, the capturing directions of the outer capturing section 23 coincide with the directions of the respective lines of sight of the user's right and left eyes.

The inner capturing section 24 is provided on the inner surface (main surface) 21B of the upper housing 21, and functions as a capturing section having a capturing direction that is the same as the inward normal direction of the inner surface 21B of the upper housing 21. The inner capturing section 24 includes an imaging device (e.g., a CCD image sensor or a CMOS image sensor) having a predetermined resolution, and a lens. The lens may have a zoom mechanism.

As shown in FIG. 1, when the upper housing 21 is in the open state, the inner capturing section 24 is placed: in the upper portion of the upper housing 21; above the upper end of the screen of the upper LCD 22; and in the center of the upper housing 21 in the left-right direction (on the line dividing the upper housing 21 (the screen of the upper LCD 22) into two equal left and right parts). Specifically, as shown in FIGS. 1 and 3B, the inner capturing section 24 is placed on the inner surface of the upper housing 21 and in the back of the middle portion between the left outer capturing section 23a and the right outer capturing section 23b. That is, if the left outer capturing section 23a and the right outer capturing section 23b provided on the outer surface of the upper housing 21 are projected onto the inner surface of the upper housing 21, the inner capturing section 24 is placed at the middle portion between the projected left outer capturing section 23a and the projected right outer capturing section 23b. The dashed line 24 shown in FIG. 3B indicates the inner capturing section 24 provided on the inner surface of the upper housing 21. Thus, the inner capturing section 24 captures an image in the direction opposite to that of the outer capturing section 23. The inner capturing section 24 is provided on the inner surface of the upper housing 21 and in the back of the middle portion between the two capturing sections of the outer capturing section 23. This makes it possible that when the user views the upper. LCD 22 from the front thereof, the inner capturing section 24 captures the user's face from the front thereof.

The 3D adjustment switch 25 is a slide switch, and is used to switch the display modes of the upper LCD 22 as described above. The 3D adjustment switch 25 is also used to adjust the stereoscopic effect of a stereoscopically visible image (stereoscopic image) displayed on the upper LCD 22. As shown in FIGS. 1 through 3D, the 3D adjustment switch 25 is provided at the end portion shared by the inner surface and the right side surface of the upper housing 21, and is placed so as to be visible to the user when the user views the upper LCD 22 from the front thereof. The 3D adjustment switch 25 includes a slider that is slidable to a given position in a predetermined direction (e.g., the up-down direction), and the display mode of the upper LCD 22 is set in accordance with the position of the slider.

When, for example, the slider of the 3D adjustment switch 25 is placed at the lowermost position, the upper LCD 22 is set to the planar display mode, and a planar image is displayed on the screen of the upper LCD 22. It should be noted that the same image may be used as the left-eye image and the right-eye image, while the upper LCD 22 remains in the stereoscopic display mode, and thereby performs planar display. On the other hand, when the slider is placed above the lowermost position, the upper LCD 22 is set to the stereoscopic display mode. In this case, a stereoscopically visible image is displayed on the screen of the upper LCD 22. When the slider is placed above the lowermost position, the visibility of the stereoscopic image is adjusted in accordance with the position of the slider. Specifically, the amount of deviation in the horizontal direction between the position of the right-eye image and the position of the left-eye image is adjusted in accordance with the position of the slider.

The 3D indicator 26 indicates whether or not the upper LCD 22 is in the stereoscopic display mode. For example, the 3D indicator 26 is an LED, and is lit on when the stereoscopic display mode of the upper LCD 22 is enabled. As shown in FIG. 1, the 3D indicator 26 is placed on the inner surface of the upper housing 21 near the screen of the upper LCD 22. Accordingly, when the user views the screen of the upper LCD 22 from the front thereof, the user can easily view the 3D indicator 26. This enables the user to easily recognize the display mode of the upper LCD 22 even while viewing the screen of the upper LCD 22.

In addition, speaker holes 21E are provided on the inner surface of the upper housing 21. Sound from the loudspeaker 44 descried later is output through the speaker holes 21E.

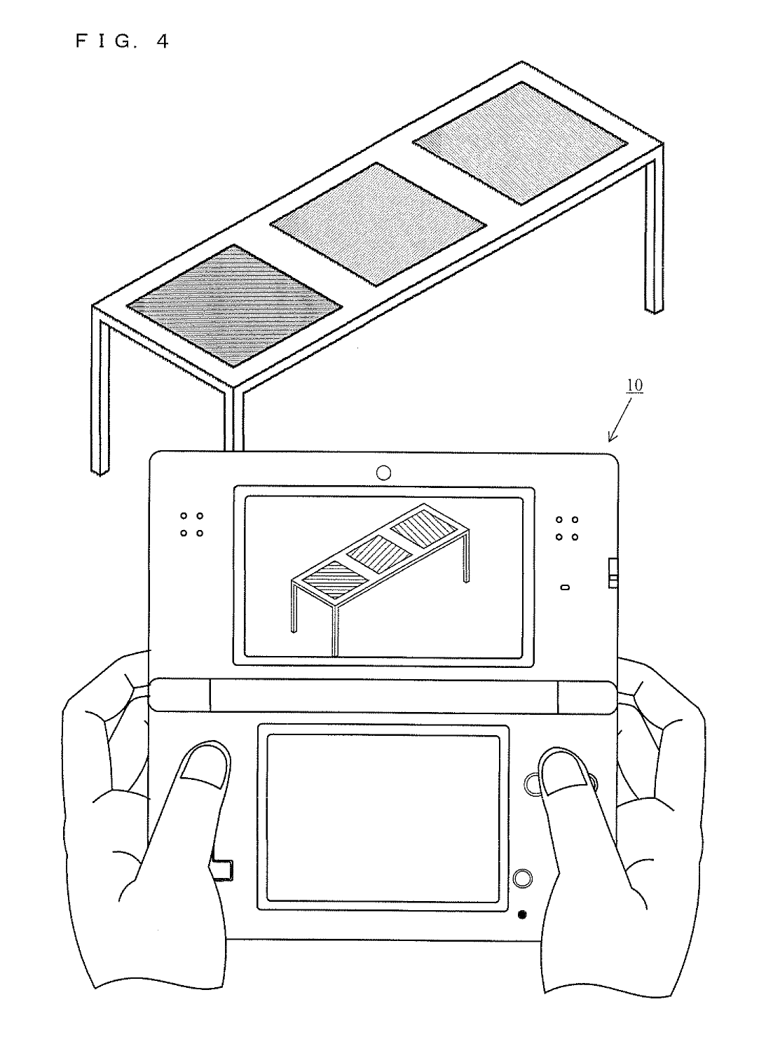

Next, with reference to FIG. 4, an example is shown of the state of the use of the game apparatus 10. It should be noted that FIG. 4 is a diagram showing an example of a user operating the game apparatus 10 holding it.

As shown in FIG. 4, the user holds the side surfaces and the outer surface (the surface opposite to the inner surface) of the lower housing 11 with both palms, middle fingers, ring fingers, and little fingers, such that the lower LCD 12 and the upper LCD 22 face the user. Such holding enables the user to perform operations on the operation buttons 14A through 14E and the analog stick 15 with their thumbs, and to perform operations on the L button 14G and the R button 14H with their index fingers, while holding the lower housing 11. In the example shown in FIG. 4, on the upper LCD 22, a real world image is displayed that is obtained by capturing the real world on the back surface side of the game apparatus 10 with the left outer capturing section 23a and the right outer capturing section 23b. Further, when an input is provided on the touch panel 13, one of the hands having held the lower housing 11 is released therefrom, and the lower housing 11 is held only with the other hand. This makes it possible to provide an input on the touch panel 13 with the one hand.

Next, with reference to FIG. 5, a description is given of the internal configuration of the game apparatus 10. It should be noted that FIG. 5 is a block diagram showing an example of the internal configuration of the game apparatus 10.

Referring to FIG. 5, the game apparatus 10 includes, as well as the components described above, electronic components, such as an information processing section 31, a main memory 32, an external memory interface (external memory I/F) 33, a data storage external memory I/F 34, a data storage internal memory 35, a wireless communication module 36, a local communication module 37, a real-time clock (RTC) 38, an acceleration sensor 39, an angular velocity sensor 40, a power circuit 41, and an interface circuit (I/F circuit) 42. These electronic components are mounted on electronic circuit boards, and are accommodated in the lower housing 11 (or may be accommodated in the upper housing 21).

The information processing section 31 is information processing means including a central processing unit (CPU) 311 that executes a predetermined program, a graphics processing unit (GPU) 312 that performs image processing, and the like. In the present embodiment, a predetermined program is stored in a memory (e.g., the external memory 45 connected to the external memory I/F 33, or the data storage internal memory 35) included in the game apparatus 10. The CPU 311 of the information processing section 31 executes the predetermined program, and thereby performs image processing described later or game processing. It should be noted that the program executed by the CPU 311 of the information processing section 31 may be acquired from another device by communication with said another device. The information processing section 31 further includes a video RAM (VRAM) 313. The GPU 312 of the information processing section 31 generates an image in accordance with an instruction from the CPU 311 of the information processing section 31, and draws the image in the VRAM 313. The GPU 312 of the information processing section 31 outputs the image drawn in the VRAM 313 to the upper LCD 22 and/or the lower LCD 12, and the image is displayed on the upper LCD 22 and/or the lower LCD 12.

To the information processing section 31, the main memory 32, the external memory I/F 33, the data storage external memory I/F 34, and the data storage internal memory 35 are connected. The external memory I/F 33 is an interface for establishing a detachable connection with the external memory 45. The data storage external memory I/F 34 is an interface for establishing a detachable connection with the data storage external memory 46.

The main memory 32 is volatile storage means used as a work area or a buffer area of the information processing section 31 (the CPU 311). That is, the main memory 32 temporarily stores various types of data used for image processing or game processing, and also temporarily stores a program acquired from outside (the external memory 45, another device, or the like) the game apparatus 10. In the present embodiment, the main memory 32 is, for example, a pseudo SRAM (PSRAM).

The external memory 45 is nonvolatile storage means for storing the program executed by the information processing section 31. The external memory 45 is composed of, for example, a read-only semiconductor memory. When the external memory 45 is connected to the external memory I/F 33, the information processing section 31 can load a program stored in the external memory 45. In accordance with the execution of the program loaded by the information processing section 31, a predetermined process is performed. The data storage external memory 46 is composed of a readable/writable non-volatile memory (e.g., a NAND flash memory), and is used to store predetermined data. For example, the data storage external memory 46 stores images captured by the outer capturing section 23 and/or images captured by another device. When the data storage external memory 46 is connected to the data storage external memory I/F 34, the information processing section 31 loads an image stored in the data storage external memory 46, and is capable of causing the image to be displayed on the upper LCD 22 and/or the lower LCD 12.

The data storage internal memory 35 is composed of a readable/writable non-volatile memory (e.g., a NAND flash memory), and is used to store predetermined data. For example, the data storage internal memory 35 stores data and/or programs downloaded by wireless communication through the wireless communication module 36.

The wireless communication module 36 has the function of establishing connection with a wireless LAN by, for example, a method based on the IEEE 802.11.b/g standard. Further, the local communication module 37 has the function of wirelessly communicating with another game apparatus of the same type by a predetermined communication method (e.g., infrared communication). The wireless communication module 36 and the local communication module 37 are connected to the information processing section 31. The information processing section 31 is capable of transmitting and receiving data to and from another device via the Internet, using the wireless communication module 36, and is capable of transmitting and receiving data to and from another game apparatus of the same type, using the local communication module 37.

The acceleration sensor 39 is connected to the information processing section 31. The acceleration sensor 39 detects the magnitudes of the accelerations in the directions of straight lines (linear accelerations) along three axial (x, y, and z axes in the present embodiment) directions, respectively. The acceleration sensor 39 is provided, for example, within the lower housing 11. As shown in FIG. 1, the long side direction of the lower housing 11 is defined as an x-axis direction; the short side direction of the lower housing 11 is defined as a y-axis direction; and the direction perpendicular to the inner surface (main surface) of the lower housing 11 is defined as a z-axis direction. The acceleration sensor 39 thus detects the magnitudes of the linear accelerations produced in the respective axial directions. It should be noted that the acceleration sensor 39 is, for example, an electrostatic capacitance type acceleration sensor, but may be an acceleration sensor of another type. Further, the acceleration sensor 39 may be an acceleration sensor for detecting an acceleration in one axial direction, or accelerations in two axial directions. The information processing section 31 receives data indicating the accelerations detected by the acceleration sensor 39 (acceleration data), and calculates the orientation and the motion of the game apparatus 10.

The angular velocity sensor 40 is connected to the information processing section 31. The angular velocity sensor 40 detects the angular velocities generated about three axes (x, y, and z axes in the present embodiment) of the game apparatus 10, respectively, and outputs data indicating the detected angular velocities (angular velocity data) to the information processing section 31. The angular velocity sensor 40 is provided, for example, within the lower housing 11. The information processing section 31 receives the angular velocity data output from the angular velocity sensor 40, and calculates the orientation and the motion of the game apparatus 10.

The RTC 38 and the power circuit 41 are connected to the information processing section 31. The RTC 38 counts time, and outputs the counted time to the information processing section 31. The information processing section 31 calculates the current time (date) on the basis of the time counted by the RTC 38. The power circuit 41 controls the power from the power supply (the rechargeable battery accommodated in the lower housing 11, which is described above) of the game apparatus 10, and supplies power to each component of the game apparatus 10.

The I/F circuit 42 is connected to the information processing section 31. A microphone 43, a loudspeaker 44, and the touch panel 13 are connected to the I/F circuit 42. Specifically, the loudspeaker 44 is connected to the I/F circuit 42 through an amplifier not shown in the figures. The microphone 43 detects sound from the user, and outputs a sound signal to the I/F circuit 42. The amplifier amplifies the sound signal from the I/F circuit 42, and outputs sound from the loudspeaker 44. The I/F circuit 42 includes: a sound control circuit that controls the microphone 43 and the loudspeaker 44 (amplifier); and a touch panel control circuit that controls the touch panel 13. For example, the sound control circuit performs A/D conversion and D/A conversion on the sound signal, and converts the sound signal into sound data in a predetermined format. The touch panel control circuit generates touch position data in a predetermined format on the basis of a signal from the touch panel 13, and outputs the touch position data to the information processing section 31. The touch position data indicates the coordinates of the position (touch position) at which an input has been provided on the input surface of the touch panel 13. It should be noted that the touch panel control circuit reads a signal from the touch panel 13, and generates the touch position data, once in a predetermined time. The information processing section 31 acquires the touch position data, and thereby recognizes the touch position, at which the input has been provided on the touch panel 13.

An operation button 14 includes the operation buttons 14A through 14L described above, and is connected to the information processing section 31. Operation data is output from the operation button 14 to the information processing section 31, the operation data indicating the states of inputs provided to the respective operation buttons 14A through 14I (indicating whether or not the operation buttons 14A through 14I have been pressed). The information processing section 31 acquires the operation data from the operation button 14, and thereby performs processes in accordance with the inputs provided on the operation button 14.

The lower LCD 12 and the upper LCD 22 are connected to the information processing section 31. The lower LCD 12 and the upper LCD 22 each display an image in accordance with an instruction from the information processing section 31 (the GPU 312). In the present embodiment, the information processing section 31 causes an image for an input operation to be displayed on the lower LCD 12, and causes an image acquired from either one of the outer capturing section 23 and the inner capturing section 24 to be displayed on the upper LCD 22. That is, for example, the information processing section 31 causes a stereoscopic image (stereoscopically visible image) using a right-eye image and a left-eye image to be displayed on the upper LCD 22, the images captured by the inner capturing section 24, or causes a planar image using one of a right-eye image and a left-eye image to be displayed on the upper LCD 22, the images captured by the outer capturing section 23.

Specifically, the information processing section 31 is connected to an LCD controller (not shown) of the upper LCD 22, and causes the LCD controller to set the parallax barrier to on/off. When the parallax barrier is on in the upper LCD 22, a right-eye image and a left-eye image that are stored in the VRAM 313 of the information processing section 31 (that are captured by the outer capturing section 23) are output to the upper LCD 22. More specifically, the LCD controller repeatedly alternates the reading of pixel data of the right-eye image for one line in the vertical direction, and the reading of pixel data of the left-eye image for one line in the vertical direction, and thereby reads the right-eye image and the left-eye image from the VRAM 313. Thus, the right-eye image and the left-eye image are each divided into strip images, each of which has one line of pixels placed in the vertical direction, and an image including the divided left-eye strip images and the divided right-eye strip images alternately placed is displayed on the screen of the upper LCD 22. The user may view the images through the parallax barrier of the upper LCD 22, whereby the right-eye image is viewed with the user's right eye, and the left-eye image is viewed with the user's left eye. This causes the stereoscopically visible image to be displayed on the screen of the upper LCD 22.

The outer capturing section 23 and the inner capturing section 24 are connected to the information processing section 31. The outer capturing section 23 and the inner capturing section 24 each capture an image in accordance with an instruction from the information processing section 31, and output data of the captured image to the information processing section 31. In the present embodiment, the information processing section 31 gives either one of the outer capturing section 23 and the inner capturing section 24 an instruction to capture an image, and the capturing section that has received the instruction captures an image, and transmits data of the captured image to the information processing section 31. Specifically, the user selects the capturing section to be used, through an operation using the touch panel 13 and the operation button 14. The information processing section 31 (the CPU 311) detects that a capturing section has been selected, and the information processing section 31 gives an instruction to capture an image to the selected one of the outer capturing section 23 and the inner capturing section 24.

The 3D adjustment switch 25 is connected to the information processing section 31. The 3D adjustment switch 25 transmits an electrical signal corresponding to the position of the slider to the information processing section 31.

The 3D indicator 26 is connected to the information processing section 31. The information processing section 31 controls whether or not the 3D indicator 26 is to be lit on. When, for example, the upper LCD 22 is in the stereoscopic display mode, the information processing section 31 lights on the 3D indicator 26.

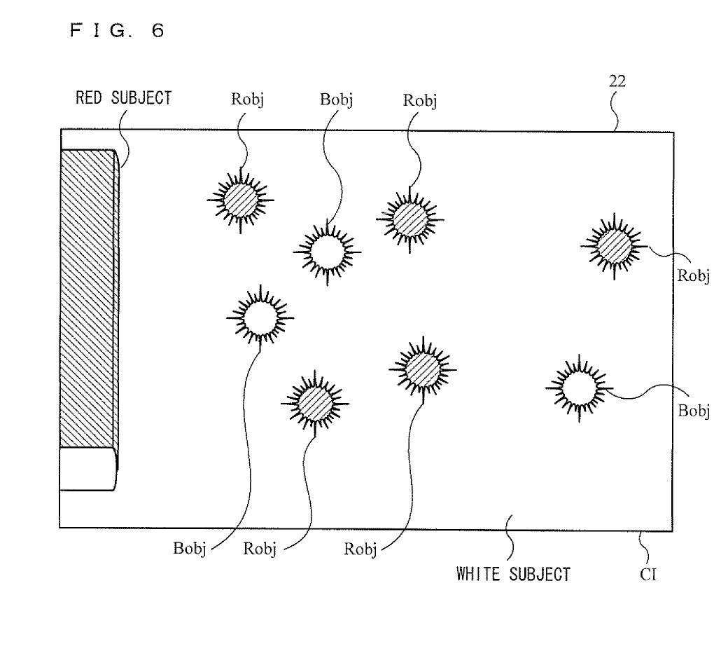

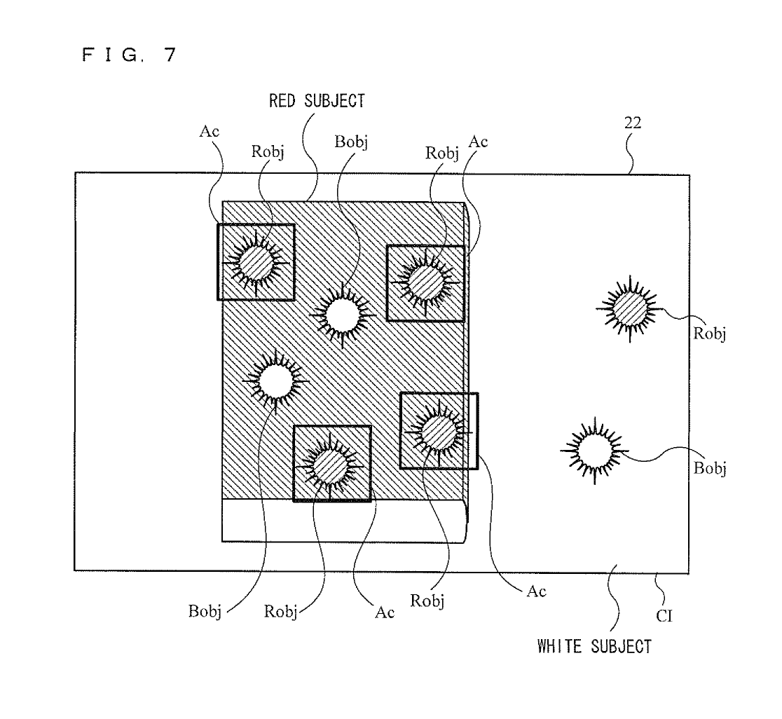

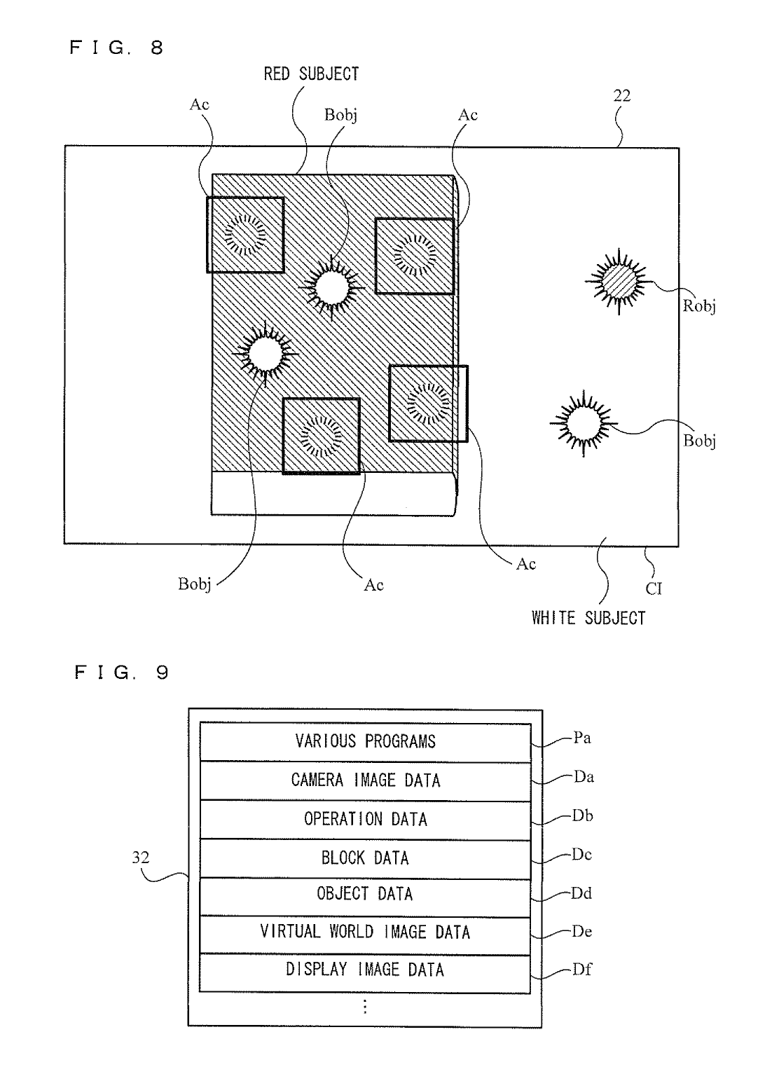

Next, before a description is given of specific image processing operations performed by the image processing program executed by the game apparatus 10, a description is given, with reference to FIGS. 6 through 8, of examples of the forms of display performed on the upper LCD 22 by the image processing operations. It should be noted that FIG. 6 is a diagram showing an example where display is performed on the upper LCD 22 such that a camera image CI and a plurality of virtual objects are combined together. FIG. 7 is a diagram showing an example where display is performed on the upper LCD 22 such that a red subject included in the camera image CI and some of the plurality of virtual objects are displayed so as to overlap each other. FIG. 8 is a diagram showing an example of an image displayed on the upper LCD 22 when a user has performed an attack operation in the state shown in FIG. 7. It should be noted that for ease of description, an example is where a planar image (a planar view image, as opposed to the stereoscopically visible image described above) of the real world on the basis of a camera image CI acquired from either one of the outer capturing section 23 and the inner capturing section 24 is displayed on the upper LCD 22.

In FIGS. 6 through 8, on the upper LCD 22, a camera image CI is displayed, which is a real world image captured by a real camera built into the game apparatus 10 (e.g., the outer capturing section 23). For example, a real-time real world image (moving image) captured by the real camera built into the game apparatus 10 is displayed on the upper LCD 22. Then, display is performed on the upper LCD 22 such that a virtual world image in which a plurality of virtual objects are placed is combined with the camera image CI. It should be noted that the screen examples shown in FIGS. 6 through 8 show scenes of a game image in which the plurality of virtual objects move at predetermined moving velocities, respectively, from the top to the bottom of the display screen. In the game, points are deducted when the virtual objects have reached a predetermined position provided in the lower portion of the display screen, and the game is over when the total of the deducted points has reached a threshold.

In FIG. 6, the virtual objects have process target colors, respectively. For example, in the example shown in FIG. 6, objects Robj having a red process target color and objects Bobj having a blue process target color are displayed on the upper LCD 22. As an example, when displayed on the upper LCD 22, the objects Robj having the red process target color are represented as red (represented as diagonal line regions in the figures) object images, and the objects Bobj having the blue process target color are represented as blue (represented as outlined regions in the figures) object images. Here, in the example shown in FIG. 6, in the camera image CI displayed on the upper LCD 22, a red subject and a white subject are captured, and all the objects Robj and Bobj are displayed so as to overlap the white subject, but are displayed so as not to overlap the red subject.

In the example shown in FIG. 7, some of the objects Robj and Bobj and the red subject captured in the camera image CI displayed on the upper LCD 22 are displayed so as to overlap each other. Then, attack cursors Ac are assigned to the objects Robj overlapping the red subject. On the other hand, the attack cursors Ac are not assigned to the objects Bobj overlapping the red subject. Further, the attack cursors Ac are not assigned to the objects Robj and Bobj overlapping the white subject, either. That is, in the example shown in FIG. 7, when the objects Robj having the red process target color and a red subject are displayed so as to overlap each other, that is, when virtual objects and a subject having a color included in the process target color of the virtual objects are displayed so as to overlap each other, display is performed such that the attack cursors Ac are assigned to the virtual objects. In this case, the process target color of the virtual objects indicates the color on the basis of which a process of assigning the attack cursors Ac is performed (typically, the regions of the color on the basis of which the process is performed).

In FIG. 8, when the user has performed an attack operation using the game apparatus 10 (e.g., pressed the operation button 14B (A button)), a predetermined attack is made on the virtual objects to which the attack cursors Ac are assigned. For example, in the example shown in FIG. 8, an attack operation of the user has caused all the objects Robj to which the attack cursors Ac are assigned, to disappear from the upper LCD 22. That is, to cause virtual objects displayed on the upper LCD 22 to disappear, the user of the game apparatus 10 needs to perform an attack operation while adjusting the capturing direction of the game apparatus 10 so that the virtual objects overlap a subject having a color that coincides with the process target color of the virtual objects. Then, by causing the virtual objects to disappear, it is possible to prevent the deduction of points when the virtual objects have reached the predetermined position provided in the lower portion of the display screen. This results in scoring higher points in the game.

It should be noted that a virtual object may disappear by being subject to a plurality of attacks. For example, when the virtual object has been attacked through the attack operation described above, a predetermined amount is subtracted from the life value of the virtual object subject to the attack. Then, the virtual object is caused to disappear when the life value has become 0 by making subtractions. In this case, a plurality of attacks may be required in order to cause the virtual object to disappear, depending on the initial life value set for the virtual object or the amount of subtraction per attack.

In addition, in the example described above, as an example, when a virtual object is displayed so as to overlap a subject having a color that coincides with the process target color of the virtual object, the virtual object serves as a target of attack. Alternatively, a target of attack may be set on the basis of another combination. In the present invention, when a virtual object is displayed so as to overlap a specific-colored subject having a predetermined relationship with the process target color of the virtual object, the virtual object may serve as a target of attack. Yet alternatively, a virtual object may disappear by attacks made as a result of the virtual object overlapping a plurality of subjects having different colors. For example, when the virtual object is displayed so as to overlap a first specific-colored subject, an attack in a first stage is allowed; when the virtual object is displayed so as to overlap a second specific-colored subject different from the first specific color, an attack in a second stage is allowed; and the virtual object disappears when the attack in the first stage and the attack of the second stage have been made. In this case, the process target color set for the virtual object is set to the first specific color in the first stage, and is set to the second specific color in the second stage.

Here, to detect a specific color from the camera image, it is possible to use color information of each pixel of the camera image. The color information of each pixel may include, for example, the RGB values, the value representing the hue, the value representing the saturation, and the value representing the brightness. In the present embodiment, any of these values may be used.

As a first example, the specific color is detected by combining the above values. Specifically, when the value representing the saturation and the value representing the brightness are equal to or greater than predetermined thresholds, respectively, and the value representing the hue is included within a predetermined range indicating the specific color, it is determined that the pixel represents the specific color. Such a determination of the specific color by combining a plurality of items of color information makes it possible to bring the determination result close to the color recognition normally performed by the user to make a distinction, while preventing erroneous color determinations.

As a second example, the specific color is detected using any one of the above values. As an example, it is possible to distinguish in the camera image a pixel having a brightness equal to or greater than a predetermined threshold, using only the value representing the brightness. In this case, when a subject having a brightness equal to or greater than the predetermined threshold overlaps a specific virtual object in the camera image, it is possible to perform image processing where the virtual object serves as a target of attack. As another example, a pixel satisfying predetermined conditions may be distinguished in the camera image as a pixel having the specific color, using only the RGB values, only the value representing the hue, or only the value representing the saturation.

It should be noted that the amount of subtraction from the life value of a virtual object through an attack operation may vary depending on the color information of the pixel overlapping the virtual object. Further, the virtual object displayed on the upper LCD 22 may be displayed on the upper LCD 22 without being combined with the camera image. In this case, the camera image captured by the real camera built into the game apparatus 10 is not displayed on the upper LCD 22, and when a specific virtual object is placed at the position overlapping a specific-colored subject captured on the assumption that the camera image and the virtual world image are combined together, the overlapping specific virtual object is set as a target of attack. That is, only a virtual space viewed from a virtual camera is displayed on the upper LCD 22. In this case, however, the camera image captured by the real camera may be displayed on the lower LCD 12.

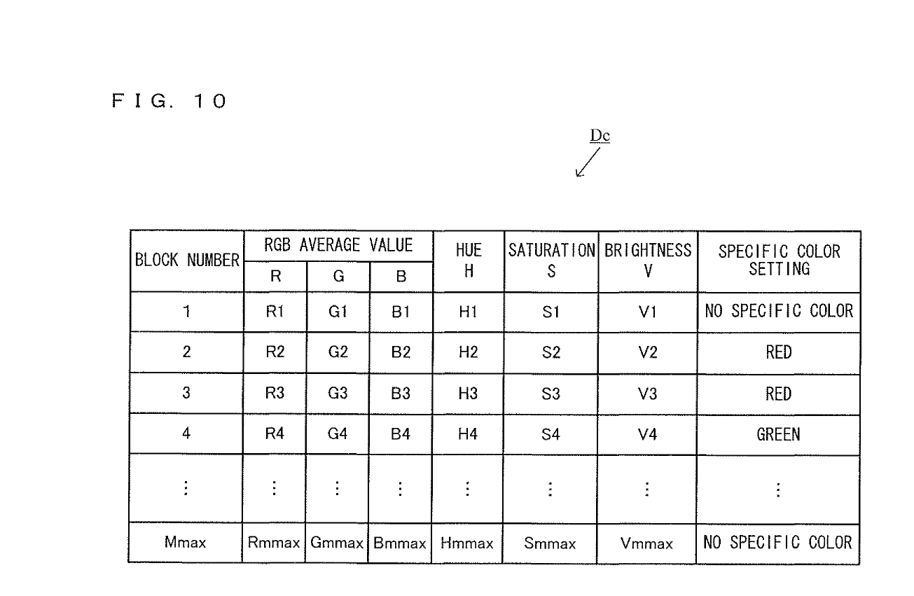

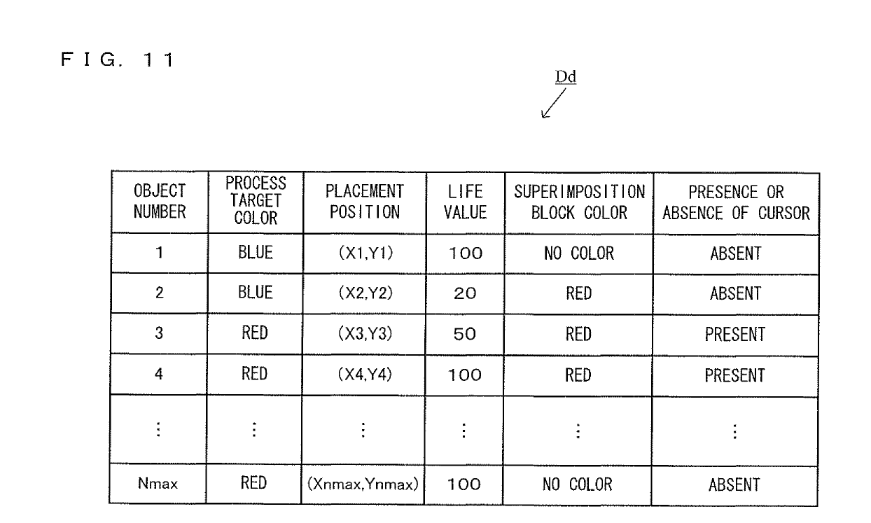

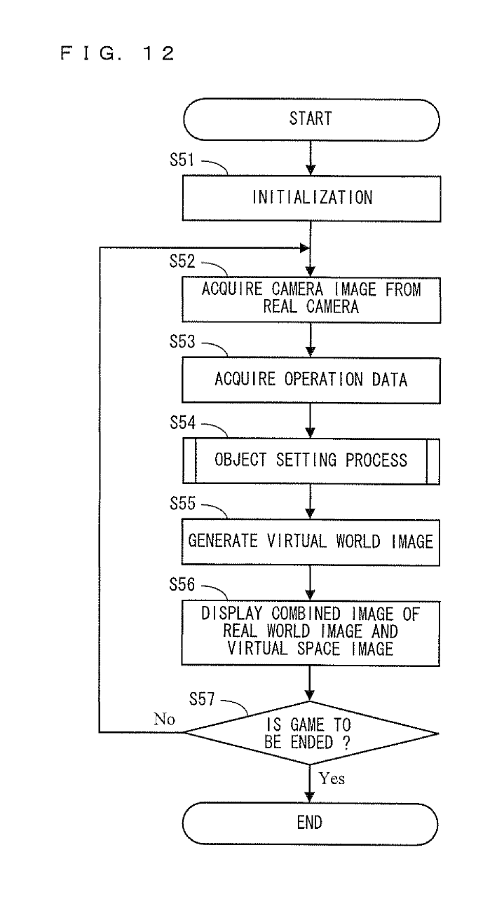

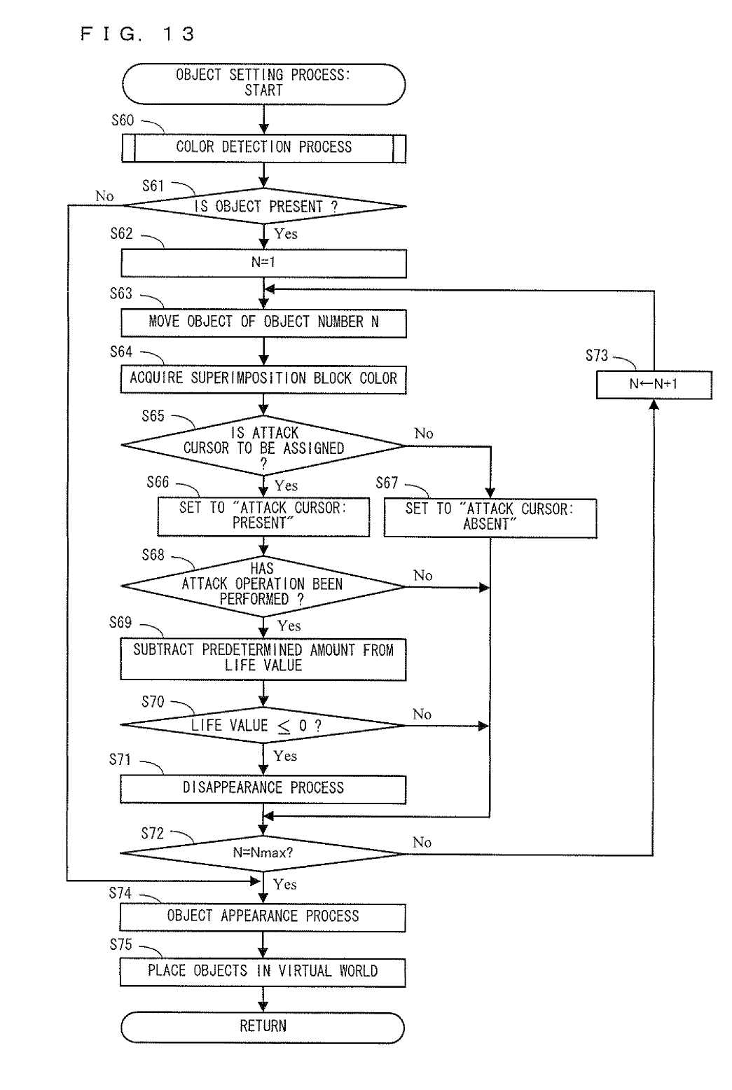

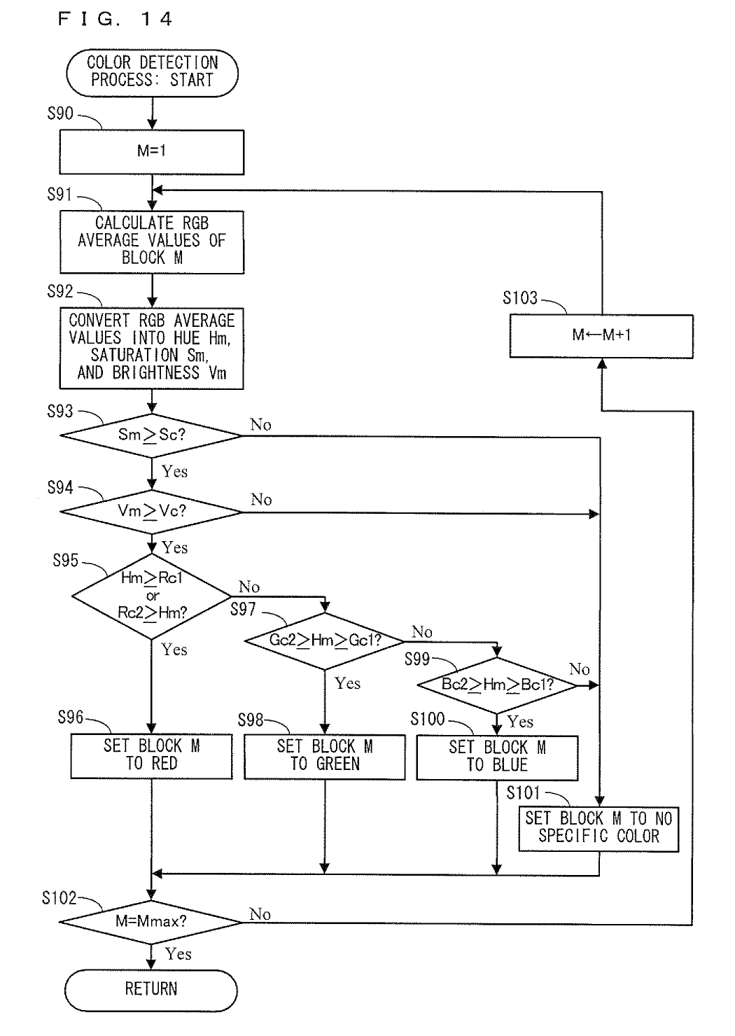

Next, with reference to FIGS. 9 through 15, a description is given of the specific processing operations performed by the image processing program executed by the game apparatus 10. It should be noted that FIG. 9 is a diagram showing an example of various data stored in the main memory 32 in accordance with the execution of the image processing program. FIG. 10 is a diagram showing an example of block data Dc of FIG. 9. FIG. 11 is a diagram showing an example of object data Dd of FIG. 9. FIG. 12 is a flow chart showing an example of the operation of image processing performed by the game apparatus 10 in accordance with the execution of the image processing program. FIG. 13 is a subroutine flow chart showing an example of a detailed operation of an object setting process performed in step 54 of FIG. 12. FIG. 14 is a subroutine flow chart showing an example of a detailed operation of a color detection process performed in step 61 of FIG. 13. It should be noted that programs for performing these processes are included in a memory built into the game apparatus 10 (e.g., the data storage internal memory 35), or included in the external memory 45 or the data storage external memory 46, and the programs are: loaded from the built-in memory, or loaded from the external memory 45 through the external memory I/F 33 or from the data storage external memory 46 through the data storage external memory I/F 34, into the main memory 32 when the game apparatus 10 is turned on; and executed by the CPU 311.

Referring to FIG. 9, the main memory 32 stores the programs loaded from the built-in memory, the external memory 45, or the data storage external memory 46, and temporary data generated in the image processing. Referring to FIG. 9, the following are stored in a data storage area of the main memory 32: camera image data Da; operation data Db; block data De; object data Dd; virtual world image data De; display image data Df; and the like. Further, in a program storage area of the main memory 32, a group of various programs Pa are stored that configure the image processing program.

The camera image data Da indicates a camera image captured by either one of the outer capturing section 23 and the inner capturing section 24. In the following descriptions of processing, in the step of acquiring a camera image, the camera image data Da is updated using a camera image captured by either one of the outer capturing section 23 and the inner capturing section 24. It should be noted that the cycle of updating the camera image data Da using the camera image captured by the outer capturing section 23 or the inner capturing section 24 may be the same as the unit of time in which the game apparatus 10 performs processing (e.g., 1/60 seconds), or may be shorter than this unit of time. When the cycle of updating the camera image data Da is shorter than the cycle of the game apparatus 10 performing processing, the camera image data Da may be updated as necessary, independently of the processing described later. In this case, in the step described later of acquiring a camera image, the process may be performed invariably using the most recent camera image indicated by the camera image data Da.

The operation data Db indicates operation information of the operation of the user on the game apparatus 10. The operation data Db indicates that the user has operated a controller, such as the operation button 14 or the analog stick 15, of the game apparatus 10. It should be noted that the operation data from the operation button 14 or the analog stick 15 is acquired per unit of time in which the game apparatus 10 performs processing (e.g., 1/60 seconds), and is stored in the operation data Db in accordance with the acquisition, to thereby be updated. It should be noted that the operation data Db may be updated in another processing cycle. For example, the operation data Db may be updated in each cycle of detecting the operation of the user on a controller, such as the operation button 14 or the analog stick 15, and the updated operation data Db may be used in each processing cycle. In this case, the cycle of updating the operation data Db differs from the processing cycle.

The block data Dc indicates a specific color determined in the camera image. With reference to FIG. 10, an example of the block data Dc is described below.

Referring to FIG. 10, as an example, the camera image captured by either one of the outer capturing section 23 and the inner capturing section 24 (hereinafter referred to simply as a “camera image”) is divided into blocks each having a predetermined size (e.g., a block of 8×8 pixels), and a specific color is determined for each block. Specifically, the camera image is divided into Mmax blocks, and block numbers 1 through Mmax are assigned to the respective blocks. Then, in the block data Dc, the following are described for each block: the RGB average values; the value representing a hue H; the value representing a saturation S; the value representing a brightness V; and specific color setting parameters indicating the determined specific color. For example, in the block of the block number 1: the RGB average values are R1, G1, and B1; the value representing the hue H is H1; the value representing the saturation S is S1; the value representing the brightness V is V1; and the specific color setting parameters indicate that no specific color is set for the block. Further, in the block of the block number 2: the RGB average values are R2, G2, and B2; the value representing the hue H is H2; the value representing the saturation S is S2; the value representing the brightness V is V2; and the specific color setting parameters indicate that it is determined that the block is red.

Referring back to FIG. 9, the object data Dd indicates various information of each object placed in the virtual space when displayed. With reference to FIG. 11, an example of the object data Dd is described below.

Referring to FIG. 11, object numbers 1 through Nmax are assigned to the respective objects placed in the virtual space when displayed. Then, in the object data Dd, data is described for each object so as to indicate: a process target color; a placement position; a life value; a superimposition block color; and the presence or absence of the cursor. Here, the process target color is information indicating a specific color on the basis of which the attack cursor Ac is assigned to the object. In the process target color, information indicating at least one specific color is described. The placement position is data indicating the position where the object is placed in the virtual world. The life value is data indicating a life value remaining for the object, and is used to cause the object to disappear when the life value has become 0 or less. The superimposition block color is data indicating a specific color set for the block overlapping the object when the object is combined with the camera image. The presence or absence of the cursor is data indicating whether or not display is performed such that the attack cursor Ac is assigned to the object. For example, in the object of the object number 1, it is indicated that: the process target color is “blue”; the placement position is “(X1, Y1)”; the life value is “100”; the superimposition block color is “absent”; and the presence or absence of the cursor is “absent”. Further, in the object of the object number 3, it is indicated that: the process target color is “red”; the placement position is “(X3, Y3)”; the life value is “50”; the superimposition block color is “red”; and the presence or absence of the cursor is “present”.

Referring back to FIG. 9, the virtual world image data De indicates the virtual world where the plurality of objects are placed. For example, the virtual world image data De indicates a two-dimensional virtual world where the objects are placed, or indicates a virtual world image obtained by performing, for example, an orthogonal projection or a perspective projection on the virtual space where the objects are placed.

The display image data Df indicates a display image to be displayed on the upper LCD 22. For example, the display image to be displayed on the upper LCD 22 is generated by superimposing the virtual world image on the camera image such that the virtual world image is given preference.

Next, with reference to FIG. 12, a description is given of the operation of the information processing section 31. First, when the power (the power button 14F) of the game apparatus 10 is turned on, the CPU 311 executes a boot program (not shown). This causes the programs stored in the built-in memory, the external memory 45, or the data storage external memory 46, to be loaded into the main memory 32. In accordance with the execution of the loaded programs by the information processing section 31 (the CPU 311), the steps (abbreviated as “S” in FIGS. 12 through 14) shown in FIG. 12 are performed. It should be noted that in FIGS. 12 through 14, processes not directly related to the present invention are not described.

Referring to FIG. 12, the information processing section 31 performs the initialization of the image processing (step 51), and proceeds to the subsequent step. As an example, when a two-dimensional virtual world where a virtual object is to be placed is set in order to generate a virtual world image, the information processing section 31 sets two-dimensional coordinate axes (e.g., X and Y axes) indicating the virtual world. As another example, when a virtual camera is set in the virtual space in order to generate a virtual world image, the information processing section 31 sets the virtual camera in the virtual space, and sets the coordinate axes (e.g., X, Y, and Z axes) of the virtual space where the virtual camera is placed. Further, the information processing section 31 initializes each of the parameters to be used in the subsequent image processing to a predetermined value (e.g., 0 or a null value).

Next, the information processing section 31 acquires a camera image from the real camera of the game apparatus 10 (step 52), and proceeds to the subsequent step. For example, the information processing section 31 updates the camera image data Da using a camera image captured by the currently selected capturing section (the outer capturing section 23 or the inner capturing section 24).

Next, the information processing section 31 acquires operation data (step 53), and proceeds to the subsequent step. For example, the information processing section 31 acquires data indicating that the operation button 14 or the analog stick 15 has been operated, to thereby update the operation data Db.

Next, the information processing section 31 performs an object setting process (step 54), and proceeds to the subsequent step. With reference to FIG. 13, an example of the object setting process is described below.

Referring to FIG. 13, the information processing section 31 performs a color detection process (step 60), and proceeds to the subsequent step. With reference to FIG. 14, an example of the color detection process is described below.

Referring to FIG. 14, the information processing section 31 sets a temporary variable M used in this subroutine to 1 (step 90), and proceeds to the subsequent step.

Next, the information processing section 31 calculates the RGB average values of a block M (step 91), and proceeds to the subsequent step. As described above, the camera image is divided into Mmax blocks. For example, the information processing section 31 extracts the RGB values of pixels corresponding to the block M (e.g., 8×8 pixels) from the camera image indicated by the camera image data Da, and calculates the average values of the respective RGB values (i.e., the average values of the respective values R, G, and B). Then, the information processing section 31 updates the block data Dc corresponding to the RGB average values of the block M, using the calculated RGB average values.

Next, the information processing section 31 converts the RGB average values calculated in step 91 described above into a hue Hm, a saturation Sm, and a brightness Vm (step 92), and proceeds to the subsequent step. Then, the information processing section 31 updates the block data Dc corresponding to the hue H, the saturation S, and the brightness V of the block M, using the values of the hue Hm, the saturation Sm, and the brightness Vm that have been obtained from the conversions.

Here, the conversions of the RGB average values into the hue Hm, the saturation Sm, and the brightness Vm may be performed using a commonly used technique. For example, if each component of the RGB average values (i.e., the values of R, G, and B) is represented as from 0.0 to 1.0; “max” is a maximum value of each component; and “min” is a minimum value of each component, the conversions into the hue Hm are performed by the following formulas.

When, among all the components, the value of R is max:

Hm=60×(G−B)/(max−min)

When, among all the components, the value of G is max:

Hm=60×(B−R)/(max−min)+120

When, among all the components, the value of B is max:

Hm=60×(R−G)/(max−min)+240

It should be noted that when Hm is a negative value as a result of the conversions using the above formulas, 360 is further added to Hm to obtain the hue Hm. Further, the conversions into the saturation Sm and the brightness Vm are performed by the following formulas.

Sm=(max−min)/max

Vm=max

When the hue Hm, the saturation Sm, and the brightness Vm are calculated using the above conversion formulas, the hue Hm is obtained in the range of from 0.0 to 360.0; the saturation Sm is obtained in the range of from 0.0 to 1.0; and the brightness Vm is obtained in the range of from 0.0 to 1.0.

Next, the information processing section 31 determines whether or not the saturation Sm calculated in step 92 described above is equal to or greater than a threshold Se (e.g., Sc=0.43) (step 93). Then, when the saturation Sm is equal to or greater than the threshold Sc, the information processing section 31 proceeds to the subsequent step 94. On the other hand, when the saturation Sm is less than the threshold Se, the information processing section 31 proceeds to the subsequent step 101.

In step 94, the information processing section 31 determines whether or not the brightness Vm calculated in step 92 described above is equal to or greater than a threshold Vc (e.g., Vc=0.125). Then, when the brightness Vm is equal to or greater than the threshold Vc, the information processing section 31 proceeds to the subsequent step 95. On the other hand, when the brightness Vm is less than the threshold Vc, the information processing section 31 proceeds to the subsequent step 101.

In step 95, the information processing section 31 determines whether or not the hue Hm calculated in step 92 described above is equal to or greater than a threshold Rc1 (e.g., Rc1=315.0) or equal to or less than a threshold Rc2 (e.g., Rc2=45.0). Then, when the determination of step 95 described above is positive, the information processing section 31 sets the block M to a specific red color to thereby update the block data De corresponding to the specific color setting of the block M (step 96), and proceeds to the subsequent step 102. On the other hand, when the determination of step 95 described above is negative, the information processing section 31 proceeds to the subsequent step 97.

In step 97, the information processing section 31 determines whether or not the hue Hm calculated in step 92 described above is equal to or greater than a threshold Gel (e.g., Gc1=75.0) and equal to or less than a threshold Gc2 (e.g., Gc2=165.0). Then, when the determination of step 97 described above is positive, the information processing section 31 sets the block M to a specific green color to thereby update the block data Dc corresponding to the specific color setting of the block M (step 98), and proceeds to the subsequent step 102. On the other hand, when the determination of step 97 described above is negative, the information processing section 31 proceeds to the subsequent step 99.

In step 99, the information processing section 31 determines whether or not the hue Hm calculated in step 92 described above is equal to or greater than a threshold Bc1 (e.g., Bc1=195.0) and equal to or less than a threshold Bc2 (e.g., Bc2=285.0). Then, when the determination of step 99 described above is positive, the information processing section 31 sets the block M to a specific blue color to thereby update the block data Dc corresponding to the specific color setting of the block M (step 100), and proceeds to the subsequent step 102. On the other hand, when the determination of step 99 described above is negative, the information processing section 31 proceeds to the subsequent step 101.

Meanwhile, in step 101, the information processing section 31 sets the block M to no specific color to thereby update the block data Dc corresponding to the specific color setting of the block M, and proceeds to the subsequent step 102. As described above, when the saturation Sm of the block M is less than the threshold Sc, or when the brightness Vm of the block M is less than the threshold Ve, or when the hue Hm of the block M is not included in any of the determination ranges used in steps 95, 97, and 98, the block M is set to no specific color.

In step 102, the information processing section 31 determines whether or not the currently set temporary variable M is Mmax. Then, when the temporary variable M is Mmax, the information processing section 31 ends the process of this subroutine. On the other hand, when the temporary variable M has not reached Mmax, the information processing section 31 adds 1 to the currently set temporary variable M to thereby set a new temporary variable (step 103), returns to step 91 described above, and repeats the same process.

Referring back to FIG. 13, after the color detection process in step 60 described above, the information processing section 31 determines whether or not an object is set in the virtual world (step 61). For example, with reference to the object data Dd, the information processing section 31 determines whether or not data of at least one virtual object is set in the object data Dd. Then, when a virtual object is set in the object data Dd, the information processing section 31 proceeds to the subsequent step 62. On the other hand, when a virtual object is not set in the object data Dd, the information processing section 31 proceeds to the subsequent step 74.

In step 62, the information processing section 31 sets the temporary variable N used in this subroutine to 1, and proceeds to the subsequent step.

Next, the information processing section 31 moves the object of the object number N in the virtual world (step 63), and proceeds to the subsequent step. For example, the information processing section 31 moves the object in the virtual world by a predetermined distance in the direction in which, when an image representing the object of the object number N is displayed on the upper LCD 22, the image moves downward on the display screen of the upper LCD 22. Then, the information processing section 31 updates the data indicating the placement position of the object of the object number N, using the position of the object moved in the virtual world, the data included in the object data Dd. It should be noted that in the case where points are deducted from the score of the game when the object has reached a predetermined region in the virtual world, if the placement position after the movement has reached the point deduction region, a process may be performed of subtracting predetermined points in accordance with the type of the object having reached the point deduction region in step 63 described above.

Next, the information processing section 31 acquires the color of the block on which the object of the object number N is superimposed (step 64), and proceeds to the subsequent step. For example, when the virtual world image is combined with the camera image, the information processing section 31 extracts the block overlapping the object of the object number N (e.g., the block overlapping the central point of the object of the object number N), and, with reference to the block data Dc, acquires the data indicating the specific color set for the block. Then, the information processing section 31 updates the data indicating the superimposition block color of the object number N, using the acquired specific color of the block, the data included in the object data Dd.

Next, the information processing section 31 determines whether or not the attack cursor Ac is to be assigned to the object of the object number N (step 65). For example, with reference to the object data Dd, the information processing section 31 determines whether or not the process target color of the object number N coincides with the superimposition block color. When the determination is positive, it is determined that the attack cursor Ac is to be assigned to the object of the object number N. Then, when the attack cursor Ac is to be assigned to the object of the object number N, the information processing section 31 proceeds to the subsequent step 66. On the other hand, when the attack cursor Ac is not to be assigned to the object of the object number N, the information processing section 31 proceeds to the subsequent step 67.

In step 66, the information processing section 31 sets the object of the object number N such that the attack cursor is present, and proceeds to the subsequent step. For example, the information processing section 31 sets the data of the object number N indicating the presence or absence of the cursor to “cursor: present”, the data included in the object data Dd.

Next, the information processing section 31 determines whether or not the user of the game apparatus 10 has performed an attack operation (step 68). For example, with reference to the operation data Db, the information processing section 31 determines whether or not the user has performed a predetermined attack operation (e.g., pressed the operation button 14B (A button)). When the attack operation has been performed, the information processing section 31 proceeds to the subsequent step 69. On the other hand, when the attack operation has not been performed, the information processing section 31 proceeds to the subsequent step 72.

In step 69, the information processing section 31 subtracts a predetermined amount from the life value of the object of the object number N, and proceeds to the subsequent step. For example, the information processing section 31 subtracts a predetermined value from the life value of the object number N indicated by the object data Dd, to thereby update the life value of the object number N using the value after the subtraction, the life value included in the object data Dd. Here, the value to be subtracted from the life value by the information processing section 31 may be determined in accordance with the settings of the game.

As a first example, the information processing section 31 makes a subtraction such that the life value of the object number N indicated by the object data Dd is 0. In this case, as a result of the user once performing an attack operation, the object serving as a target of attack disappears from the virtual world. As a second example, the information processing section 31 subtracts a fixed value defined in advance from the life value of the object number N indicated by the object data Dd. In this case, on the basis of the relative value difference between the initial value of the life value defined for the object and the fixed value, it is possible to adjust the number of attacks required until the object is caused to disappear. As a third example, the information processing section 31 subtracts the value calculated in accordance with the color information of the superimposition block, from the life value of the object number N indicated by the object data Dd. Here, when the virtual world image is combined with the camera image in step 64 described above, the block overlapping the object of the object number N has been extracted, and the RGB average values, the hue, the saturation, and the brightness that are set for the block have been set in the block data Dc. For example, the information processing section 31 sets the value to be subtracted from the life value, on the basis of at least one of the RGB average values, the hue, the saturation, and the brightness that are set for the block overlapping the object of the object number N. In this case, the number of attacks required until the object is caused to disappear varies depending on the color of the subject displayed so as to overlap the object. This makes it possible to vary the intensity of the attack to be made on the object, depending on the color of the subject displayed so as to overlap the object.

In addition, in accordance with an attack made on the object, the process target color of the object may be changed in step 69 described above. Consequently, to cause the object to disappear by further attacking it, it is necessary to perform an attack operation while displaying the object so as to overlap another specific-colored subject. This further enhances the interest of the game.

Next, the information processing section 31 determines whether or not the life value of the object of the object number N is equal to or less than 0 (step 70). For example, with reference to the life value of the object number N indicated by the object data Dd, the information processing section 31 determines whether or not the life value indicates 0 or less. Then, when the life value of the object of the object number N is equal to or less than 0, the information processing section 31 proceeds to the subsequent step 71. On the other hand, when the life value of the object of the object number N is greater than 0, the information processing section 31 proceeds to the subsequent step 72.

In step 71, the information processing section 31 performs a process of causing the object of the object number N to disappear, and proceeds to the subsequent step 72. For example, the information processing section 31 performs the process of causing the object of the object number N to disappear, by deleting the data of the object number N from the object data Dd. It should be noted that in the case where points are added to the score of the game when the object has been deleted from the virtual world, a process may be performed of adding predetermined points in accordance with the type of the object having disappeared in step 71 described above.

On the other hand, when it is determined in step 65 described above that the attack cursor Ac is not to be assigned to the object of the object number N, the information processing section 31 sets the object of the object number N such that the attack cursor is absent, and proceeds to the subsequent step 72. For example, the information processing section 31 sets the data of the object number N indicating the presence or absence of the cursor to “cursor: absent”, the data included in the object data Dd.

In step 72, the information processing section 31 determines whether or not the currently set temporary variable N is Nmax. Then, when the temporary variable N is Nmax, the information processing section 31 proceeds to the subsequent step 74. On the other hand, when the temporary variable N has not reached Nmax, the information processing section 31 adds 1 to the currently set temporary variable N to thereby set a new temporary variable N (step 73), returns to step 63 described above, and repeats the same process.

In step 74, the information processing section 31 performs a process of causing objects to newly appear in the virtual world, and proceeds to the subsequent step. For example, on the basis of a predetermined algorithm, the information processing section 31 determines whether or not objects are to be caused to newly appear. When objects are to be caused to appear, the information processing section 31 sets the number of the objects to appear, the appearance positions of the objects, the types (the process target colors and the initial life values) of the objects to appear, and the like on the basis of the algorithm. Then, using the set information of the objects, the information processing section 31 adds to the object data Dd the data indicating the objects to appear. It should be noted that the data of the objects to appear may be added in ascending order from the largest object number already stored in the object data Dd. Alternatively, if there is a vacancy in the object numbers as a result of the disappearance process in step 71 described above, the data may be added to the vacancy. It should be noted that also after the above process of causing objects to appear, if there is a vacancy in the object numbers as a result of the disappearance process in step 71 described above, data is moved sequentially so as to fill the vacancy. Further, if the number of objects described in the object data Dd has increased or decreased as a result of the process of step 74 described above, the determination value Nmax used in step 72 described above varies depending on the increase or the decrease.

Next, the information processing section 31 places the objects in the virtual world (step 75), and ends the process of this subroutine. For example, with reference to the object data Dd, the information processing section 31 places each object in the virtual world on the basis of the placement position, the process target color, and the presence or absence of the cursor that have been set. As an example, when placing the objects in a two-dimensional virtual world, the information processing section 31 places the objects on the basis of the set two-dimensional coordinate axes indicating the virtual world. Then, to the objects set to “cursor: present”, rectangular or circular attack cursors Ac are assigned so as to surround the objects, respectively. As another example, when placing the objects in a three-dimensional virtual space, the information processing section 31 places the objects on the basis of the set three-dimensional coordinate axes indicating the virtual space. Then, to the objects set to “cursor: present”, solids corresponding to attack cursors Ac (e.g., cubes or cuboids, only whose frames are non-transparent, or semi-transparent spheres) are assigned so as to surround the objects, respectively. It should be noted that the color of each object to be placed in the virtual world may be set in accordance with the process target color of the object. For example, the color of the object may be set to the same color as the set process target color of the object, or the color of the object may be set to the complementary color of the set process target color (i.e., blue-green for red, purple-red for green, yellow for blue, and the like) of the object. In the first case, the color of the object makes it possible to directly indicate to the user the color of a subject on the basis of which the object is caused to disappear. Alternatively, in the second case, the complementary color of the color of the object is the color of a subject on the basis of which the object is caused to disappear. This makes it possible to cause the user to advance the game taking into account the relationship of the complementary color.

Referring back to FIG. 12, after the object setting process in step 54 described above, the information processing section 31 performs a process of generating a virtual world image (step 55), and proceeds to the subsequent step. For example, when the objects are placed in the two-dimensional virtual world, the information processing section 31 generates, as a virtual world image, an image representing the virtual world including the objects, to thereby update the virtual world image data De. Further, when the objects are placed in the three-dimensional virtual space, the information processing section 31 updates the virtual world image data De using an image obtained by rendering the virtual space where the objects are placed. For example, the information processing section 31 generates a virtual world image by rendering with a perspective projection or an orthogonal projection from the virtual camera the objects placed in the virtual space, to thereby update the virtual world image data De using the generated virtual world image.

Next, the information processing section 31 generates a display image obtained by combining the camera image with the virtual world image, displays the display image on the upper LCD 22 (step 56), and proceeds to the subsequent step. For example, the information processing section 31 acquires the camera image indicated by the camera image data Da and the virtual world image indicated by the virtual world image data De, and generates a display image by superimposing the virtual world image on the camera image such that the virtual world image is given preference, to thereby update the display image data Df using the display image. Further, the CPU 311 of the information processing section 31 stores the display image indicated by the display image data Df in the VRAM 313. Then, the GPU 312 of the information processing section 31 may output the display image drawn in the VRAM 313 to the upper LCD 22, whereby the display image is displayed on the upper LCD 22. It should be noted that when a virtual world image is not stored in the virtual world image data De, the information processing section 31 may use the camera image indicated by the camera image data Da as it is as the display image.

Next, the information processing section 31 determines whether or not the game is to be ended (step 57). Conditions for ending the game may be, for example: that particular conditions have been satisfied so that the game is over; or that the user has performed an operation for ending the game. When the game is not to be ended, the information processing section 31 proceeds to step 52 described above, and repeats the same process. On the other hand, when the game is to be ended, the information processing section 31 ends the process of the flow chart.

As described above, in the image processing according to the above embodiment, process target colors are set for virtual objects, respectively. When the color of a subject displayed so as to overlap a virtual object in the camera image obtained from the real camera is substantially the same as the process target color of the virtual object, the virtual object serves as a target of attack. Accordingly, to cause the virtual object to disappear by attacking it, the user needs to perform an attack operation while adjusting the positional relationship between a specific-colored subject in the camera image and a virtual object image combined with the camera image. This makes it possible to provide a game where a new process is performed on a virtual object, using a real world image.

It should be noted that in the above descriptions, three colors, namely, “red”, “green”, and “blue”, are the specific colors that can be set for blocks, that is, the process target colors that can be set for virtual objects and the specific colors that can be set for subjects included in the camera image. Alternatively, other colors and other attributes may serve as the process target colors of virtual objects and the specific colors of subjects. For example, other hues, such as orange, yellow, purple, and pink, may be set as the process target colors of virtual objects and the specific colors of subjects. Achromatic colors, such as black, gray, and white, may be set as the process target colors of virtual objects and the specific colors of subjects. Alternatively, a color brighter or a color darker than a predetermined threshold (a color having a relatively high brightness or a color having a relatively low brightness), or a color closer to or a color further from a pure color than a predetermined threshold (a color having a relatively high saturation or a color having a relatively low saturation) may be set as the process target color of a virtual object and the specific color of a subject. It is needless to say that the use of at least one of the items of the color information, namely, the RGB values, the hue, the saturation, and the brightness, enables a virtual object setting process similar to the above.

In addition, in the above descriptions, as an example, the process is performed on all the blocks of the camera image such that when the color information (the RGB average values, the hue, the saturation, and the brightness) of each block is included in a predetermined range, a specific color is set for the block. Then, when the process target color of a virtual object coincides with the specific color, the virtual object serves as a target of attack. Alternatively, the process of determining whether or not the process target color substantially coincides with the specific color may be performed using another method. As a first example, the range of the color information (the RGB average values, the hue, the saturation, and the brightness) corresponding to the process target color of each virtual object is set. Then, when the color information of the block of the camera image displayed so as to overlap the virtual object is included in the set range, the virtual object serves as a target of attack. In this case, it is also possible to perform, only on the blocks of the camera image displayed so as to overlap the virtual object, the process of determining whether or not the process target color substantially coincides with the specific color. As a second example, the process of determining the specific color is performed only on the blocks of the camera image displayed so as to overlap a virtual object. That is, when the color information of a block displayed so as to overlap a virtual object is included in a predetermined range, a specific color is set for the block. Then, when the specific color coincides with the process target color of the virtual object overlapping the block, the virtual object serves as a target of attack.

In addition, an image obtained by inverting the lightness and darkness or the colors of a subject (a negative image) in the camera image captured by the real camera may be displayed on the upper LCD 22. In this case, the information processing section 31 may invert the RGB values of the entire camera image stored in the camera image data Da, whereby it is possible to generate the negative image. Specifically, when the RGB values of the camera image are each indicated as a value of from 0 to 255, the values obtained by subtracting each of the ROB values from 255 are obtained as the RGB values (e.g., in the case of the RGB values (150, 120, 60), the RGB values (105, 135, 195) are obtained). This makes it possible to invert the RGB values as described above. In this ease, to perform a predetermined process on the virtual object, the player of the game apparatus 10 needs to overlap the virtual object on the subject captured in the complementary color (e.g., blue-green when the process target color is red) of the process target color of the virtual object (i.e., the color on the basis of which the predetermined process is performed on the virtual object) in the negative image displayed on the upper LCD 22, and requires new thought to advance the game. It should be noted that in the progression of the game, occurrence of a specific time or entry of a specific state may trigger a change from the camera image displayed on the upper LCD 22 to the negative image.

In addition, in the above descriptions, as an example, the camera image is divided into blocks each having a predetermined size, and a specific color is set for each block. Alternatively, a specific color may be set in another unit. For example, a specific color may be set for each pixel in the camera image.

In addition, in the game example described above, the attack cursor Ac is assigned to a virtual object serving as a target of attack. Alternatively, a game image may be generated without assigning the attack cursor Ac to a target of attack. In this case, although a virtual object serving as a target of attack cannot be indicated to the user of the game apparatus 10 before an attack operation, a similar attack is made on the target of attack as a result of the user performing the attack operation. Accordingly, when a target of attack is not indicated to the user before an attack operation and the specific color of a subject is substantially the same as the process target color of a virtual object displayed so as to overlap the subject, the virtual object is attacked in accordance with the attack operation. This makes it possible to provide a more interesting game.

In addition, in the game example described above, when the specific color of a subject is substantially the same as the process target color of a virtual object displayed so as to overlap the subject, the virtual object overlapping the subject is subject to an attack process. Alternatively, another process may be performed on the virtual object.

As a first example, when the specific color of a subject is substantially the same as the process target color of a virtual object displayed so as to overlap the subject, the life value of the virtual object overlapping the subject is increased by a predetermined amount. In this case, the process target color on the basis of which a process is performed of setting the virtual object as a target of attack, and the process target color on the basis of which a process is performed of increasing the life value of the virtual object, may be set to colors different from each other. Then, both processes may be performed.

As a second example, when the specific color of a subject is substantially the same as the process target color of a virtual object displayed so as to overlap the subject, the moving velocity and the moving direction of the virtual object overlapping the subject are changed. In this case, the process target color on the basis of which a process is performed of setting the virtual object as a target of attack, and the process target color on the basis of which a process is performed of changing the moving velocity and the moving direction of the virtual object, may be set to the same color or colors different from each other. Then, both the process of setting the virtual object as a target of attack and the process of changing the moving velocity and the moving direction of the virtual object may be performed. For example, when both process target colors are set to the same color, it is also possible to represent a game image on the upper LCD 22 such that when the subject on the basis of which the virtual object is set as a target of attack and the virtual object are displayed so as to overlap each other, the virtual object escapes from the subject by changing the moving velocity and the moving direction of the virtual object.

As a third example, when the specific color of a subject is substantially the same as the process target color of a virtual object displayed so as to overlap the subject, the number of displayed parts of the virtual object overlapping the subject is changed by disintegrating the virtual object, integrating parts of the virtual object, or temporarily making the virtual object transparent (i.e., deleting the virtual object). Also in this case, the process target color on the basis of which a process is performed of setting the virtual object as a target of attack, and the process target color on the basis of which a process is performed of changing the number of displayed parts of the virtual object, may be set to the same color or colors different from each other. Then, both the process of setting the virtual object as a target of attack and the process of changing the number of displayed parts of the virtual object may be performed. For example, when both process target colors are set to the same color, it is also possible to represent a game image on the upper LCD 22 such that when the subject on the basis of which the virtual object is set as a target of attack and the virtual object are displayed so as to overlap each other, the virtual object defends against an attack of the user by disintegrating itself, integrating parts of it, or disappearing.

In addition, a plurality of process target colors may be set as the process target colors on the basis of which a predetermined process is performed on a virtual object. For example, when red and blue are set as the process target colors of a virtual object, if the virtual object overlaps a red subject, a predetermined process is performed on the virtual object, and also if the virtual object overlaps a blue subject, the same predetermined process is performed on the virtual object.

In addition, in the game example described above, process target colors are set for virtual objects, respectively. Then, when the color of a subject displayed so as to overlap the virtual objects in the camera image obtained from the real camera is substantially the same as the process target color of the virtual objects, a predetermined process is performed on all the virtual objects. Alternatively, the predetermined process may be performed on some of the virtual objects.

In addition, in the game example described above, when the specific color of a subject is substantially the same as the process target color of a virtual object displayed so as to overlap the subject, a predetermined process is performed on the virtual object overlapping the subject. Alternatively, the process may be performed also on a virtual object not overlapping the subject. For example, if a subject having a specific color that is substantially the same as the process target colors of virtual objects is captured in the camera image displayed on the upper LCD 22, a predetermined process may be performed on, among virtual objects displayed on the upper LCD 22, all the virtual objects whose process target colors are the specific color. In this case, when performing the predetermined process on the virtual objects, the user of the game apparatus 10 does not need to display the virtual objects and the specific-colored subject so as to overlap each other, but only needs to capture with the real camera the specific-colored subject so as to be included at least in the capturing range. In this case, process target colors are set for virtual objects, respectively. Then, when the color of a subject displayed in the camera image obtained from the real camera is substantially the same as the process target colors, the predetermined process is performed on all the virtual objects for which the process target colors are set. Alternatively, the predetermined process may be performed on some of the virtual objects.

In addition, in the above descriptions, as an example, a camera image CI acquired from either one of the outer capturing section 23 and the inner capturing section 24 is displayed on the upper LCD 22 as a planar image (a planar view image, as opposed to the stereoscopically visible image described above) of the real world. Alternatively, a real world image stereoscopically visible with the naked eye (a stereoscopic image) may be displayed on the upper LCD 22. For example, as described above, the game apparatus 10 can display on the upper LCD 22 a stereoscopically visible image (stereoscopic image) using camera images acquired from the left outer capturing section 23a and the right outer capturing section 23b. In this case, in accordance with the positional relationship between a specific-colored subject included in the stereoscopic image displayed on the upper LCD 22 and a virtual object whose process target color is the specific color, a predetermined process is performed on the virtual object.

For example, to perform drawing such that the predetermined process is performed on the virtual object in accordance with the specific-colored subject included in the stereoscopic image, the image processing described above is performed using a left-eye image obtained from the left outer capturing section 23a and a right-eye image obtained from the right outer capturing section 23b. Specifically, in the image processing shown in FIG. 12, a perspective transformation may be performed from two virtual cameras (a stereo camera), on the object placed in the virtual world, whereby a left-eye virtual world image and a right-eye virtual world image are obtained. Then, a left-eye display image is generated by combining a left-eye image (a camera image obtained from the left outer capturing section 23a) with the left-eye virtual world image, and a right-eye display image is generated by combining a right-eye image (a camera image obtained from the right outer capturing section 23b) with the right-eye virtual world image. Then, the left-eye display image and the right-eye display image are output to the upper LCD 22.

In addition, in the above descriptions, a real-time moving image captured by the real camera built into the game apparatus 10 is displayed on the upper LCD 22, and display is performed such that the moving image (camera image) captured by the real camera is combined with the virtual world image. In the present invention, however, the images to be displayed on the upper LCD 22 have various possible variations. As a first example, a moving image recorded in advance, or a moving image or the like obtained from television broadcast or another device, is displayed on the upper LCD 22. In this case, the moving image is displayed on the upper LCD 22, and when a specific-colored subject is included in the moving image, a predetermined process is performed on a virtual object in accordance with the specific-colored subject. As a second example, a still image obtained from the real camera built into the game apparatus 10 or another real camera is displayed on the upper LCD 22. In this case, the still image obtained from the real camera is displayed on the upper LCD 22, and when a specific-colored subject is included in the still image, a predetermined process is performed on a virtual object in accordance with the specific-colored subject. Here, the still image obtained from the real camera may be a still image of the real world captured in real time by the real camera built into the game apparatus 10, or may be a still image of the real world captured in advance by the real camera or another real camera, or may be a still image obtained from television broadcast or another device.

In addition, in the above embodiment, the upper LCD 22 is a parallax barrier type liquid crystal display device, and therefore is capable of switching between stereoscopic display and planar display by controlling the on/off states of the parallax barrier. In another embodiment, for example, the upper LCD 22 may be a lenticular type liquid crystal display device, and therefore may be capable of displaying a stereoscopic image and a planar image. Also in the case of the lenticular type, an image is displayed stereoscopically by dividing two images captured by the outer capturing section 23, each into vertical strips, and alternately arranging the divided vertical strips. Also in the case of the lenticular type, an image can be displayed in a planar manner by causing the user's right and left eyes to view one image captured by the inner capturing section 24. That is, even the lenticular type liquid crystal display device is capable of causing the user's left and right eyes to view the same image by dividing one image into vertical strips, and alternately arranging the divided vertical strips. This makes it possible to display an image, captured by the inner capturing section 24, as a planar image.

In addition, in the above embodiment, as an example of a liquid crystal display section including two screens, the descriptions are given of the case where the lower LCD 12 and the upper LCD 22, physically separated from each other, are placed above and below each other (the case where the two screens correspond to upper and lower screens). The present invention, however, can be achieved also with an apparatus having a single display screen (e.g., only the upper LCD 22), or an apparatus that performs image processing on an image to be displayed on a single display device. Alternatively, the structure of a display screen including two screens may be another structure. For example, the lower LCD 12 and the upper LCD 22 may be placed on the left and right of a main surface of the lower housing 11. Alternatively, a higher-than-wide LCD that is the same in width as and twice the height of the lower LCD 12 (i.e., physically one LCD having a display size of two screens in the vertical direction) may be provided on a main surface of the lower housing 11, and two images (e.g., a captured image and an image indicating an operation instruction screen) may be displayed on the upper and lower portions of the main surface (i.e., displayed adjacent to each other without a boundary portion between the upper and lower portions. Yet alternatively, an LCD that is the same in height as and twice the width of the lower LCD 12 may be provided on a main surface of the lower housing 11, and two images may be displayed on the left and right portions of the main surface (i.e., displayed adjacent to each other without a boundary portion between the left and right portions). In other words, two images may be displayed using two divided portions in what is physically a single screen. Further, when two images are displayed using two divided portions in what is physically a single screen, the touch panel 13 may be provided on the entire screen.

In addition, in the above descriptions, the touch panel 13 is integrated with the game apparatus 10. It is needless to say, however, that the present embodiment can also be achieved with the structure where a game apparatus and a touch panel are separated from each other. Further, the touch panel 13 may be provided on the surface of the upper LCD 22, and the display image displayed on the lower LCD 12 in the above descriptions may be displayed on the upper LCD 22. Furthermore, when the present embodiment is achieved, the touch panel 13 may not need to be provided.

In addition, in the above embodiment, the descriptions are given using the hand-held game apparatus 10. The image processing program according to the present embodiment, however, may be executed by an information processing apparatus, such as a stationary game apparatus and a general personal computer. In this case, the use of a capturing device that allows the user to change the capturing direction and the capturing position thereof makes it possible to achieve similar image processing, using a real world image obtained from the capturing device. Alternatively, in another embodiment, not only a game apparatus but also a given hand-held electronic device may be used, such as a personal digital assistant (PDA), a mobile phone, a personal computer, or a camera. For example, a mobile phone may include a display section and a real camera on the main surface of a housing.

In addition, in the above descriptions, the image processing is performed by the game apparatus 10. Alternatively, at least some of the process steps in the image processing may be performed by another device. For example, when the game apparatus 10 is configured to communicate with another device (e.g., a server or another game apparatus), the process steps in the image processing may be performed by the cooperation of the game apparatus 10 and said another device. As an example, a case is possible where: the game apparatus 10 performs a process of setting a camera image; another device acquires data concerning the camera image from the game apparatus 10, and performs the processes of steps 53 through 57; and a display image obtained by combining the camera image with the virtual world is acquired from said another device, and is displayed on a display device of the game apparatus 10 (e.g., the upper LCD 22). As another example, a case is possible where: another device performs a process of setting a camera image; and the game apparatus 10 acquires data concerning the camera image, and performs the processes of steps 53 through 57. Thus, when at least some of the process steps in the image processing is performed by another device, it is possible to perform processing similar to the image processing described above. That is, the image processing described above can be performed by a processor or by the cooperation of a plurality of processors, the processor and the plurality of processors included in an image processing system that includes at least one information processing apparatus. Further, in the above embodiment, the processing of the flow chart described above is performed in accordance with the execution of a predetermined program by the information processing section 31 of the game apparatus 10. Alternatively, some or all of the processing may be performed by a dedicated circuit provided in the game apparatus 10.

It should be noted that the shape of the game apparatus 10, and the shapes, the number, the placement, or the like of the various buttons of the operation button 14, the analog stick 15, and the touch panel 13 that are provided in the game apparatus 10 are merely illustrative, and the present invention can be achieved with other shapes, numbers, placements, and the like. Further, the processing orders, the setting values, the formulas, the criterion values, and the like that are used in the image processing described above are also merely illustrative, and it is needless to say that the above embodiment can be achieved with other orders, values, and formulas.

It should be noted that the image processing program (game program) described above may be supplied to the game apparatus 10 not only from an external storage medium, such as the external memory 45 or the data storage external memory 46, but also via a wireless or wired communication link. Further, the program may be stored in advance in a non-volatile storage device of the game apparatus 10. It should be noted that examples of an information storage medium having stored thereon the program may include a CD-ROM, a DVD, and another given optical disk storage medium similar to these, a flexible disk, a hard disk, a magnetic optical disk, and a magnetic tape, as well as a non-volatile memory. Furthermore, the information storage medium for storing the program may be a volatile memory that temporarily stores the program.

While the invention has been described in detail, the foregoing description is in all aspects illustrative and not restrictive. It is understood that numerous other modifications and variations can be devised without departing from the scope of the invention. It is understood that the scope of the invention should be interpreted only by the appended claims. Further, throughout the specification, it should be understood that terms in singular form include the concept of plurality unless otherwise specified. Thus, it should be understood that articles or adjectives indicating the singular form (e.g., “a”, “an”, “the”, and the like in English) include the concept of plurality unless otherwise specified. It is also understood that one skilled in the art can implement the invention in the equivalent range on the basis of the description of the invention and common technical knowledge, from the description of the specific embodiments of the invention. Furthermore, it should be understood that terms used in the present specification have meanings generally used in the art unless otherwise specified. Therefore, unless otherwise defined, all the jargons and technical terms have the same meanings as those generally understood by one skilled in the art of the invention. In the event of any contradiction, the present specification (including meanings defined herein) has priority.

A storage medium having stored thereon an image processing program, an image processing apparatus, an image processing system, and an image processing method, according to the present invention can perform a new process on a virtual object using a real world image, and therefore are suitable for use as an image processing program, an image processing apparatus, an image processing system, an image processing method, and the like that perform, for example, a process of performing image processing on various images.

What is claimed is:

1. A computer-readable storage medium having stored thereon an image processing program to be executed by a computer of an image processing apparatus that processes an image to be displayed on a display device, the image processing program causing the computer to function as:
captured image acquisition means for acquiring a captured image captured by a real camera;
object placement means for placing in a virtual world at least one virtual object for which a predetermined color is set;
color detection means for, in the captured image acquired by the captured image acquisition means, detecting at least one pixel corresponding to the predetermined color set for the virtual object placed in the virtual world, using color information including at least one selected from the group including RGB values, a hue, a saturation, and a brightness of each pixel of the captured image;
object process means for, when the color detection means has detected the pixel corresponding to the predetermined color, performing a predetermined process on the virtual object for which the predetermined color is set; and
image display control means for displaying on the display device an image of the virtual world where at least the virtual object is placed.

2. The computer-readable storage medium having stored thereon the image processing program according to claim 1, the image processing program further causing the computer to function as:
image combination means for generating a combined image obtained by combining the captured image acquired by the captured image acquisition means with the image of the virtual world where the virtual object is placed, wherein
the image display control means displays the combined image generated by the image combination means on the display device.

3. The computer-readable storage medium having stored thereon the image processing program according to claim 2, wherein
when the image combination means combines the captured image with the image of the virtual world, the object process means performs the predetermined process on, among the virtual objects for which the predetermined color is set, a virtual object that overlaps the pixel corresponding to the predetermined color when combined with the captured image.

4. The computer-readable storage medium having stored thereon the image processing program according to claim 1, wherein
the object placement means places in the virtual world a plurality of virtual objects for which the predetermined color is set, and
the object process means performs the predetermined process on, among the plurality of virtual objects for which the predetermined color is set, all the virtual objects that, when combined with the captured image, overlap pixels corresponding to a predetermined color that is the same as the predetermined color.

5. The computer-readable storage medium having stored thereon the image processing program according to claim 1, the image processing program further causing the computer to function as:
operation signal acquisition means for acquiring an operation signal in accordance with an operation of a user, wherein
when the color detection means has detected the pixel corresponding to the predetermined color and the operation signal acquisition means has acquired an operation signal indicating an operation of making an attack on a virtual object, the object process means makes a predetermined attack on the virtual object for which the predetermined color is set.

6. The computer-readable storage medium having stored thereon the image processing program according to claim 1, wherein
when the color detection means has detected the pixel corresponding to the predetermined color, the object process means sets a predetermined sign for the virtual object for which the predetermined color is set, and
the image display control means assigns the sign set by the object process means to the virtual object, and displays on the display device an image of the virtual world where the virtual object to which the sign is assigned is placed.

7. The computer-readable storage medium having stored thereon the image processing program according to claim 5, wherein
the object process means causes the virtual object on which the predetermined attack has been made, to disappear from the virtual world.

8. The computer-readable storage medium having stored thereon the image processing program according to claim 1, wherein
the color detection means detects, as the pixel corresponding to the predetermined color, a pixel having items of the color information indicating the saturation and the brightness that are equal to or greater than predetermined thresholds, respectively, and also having an item of the color information indicating the hue indicative of a value within a predetermined range.

9. The computer-readable storage medium having stored thereon the image processing program according to claim 1, wherein
a display color of the virtual object for which the predetermined color is set is set to substantially the same color as the predetermined color, and
the image display control means displays on the display device the virtual object for which the predetermined color is set, such that the set display color is included at least in part of an image representing the virtual object.

10. The computer-readable storage medium having stored thereon the image processing program according to claim 1, wherein
a display color of the virtual object for which the predetermined color is set is set to a substantially complementary color of the predetermined color, and
the image display control means displays on the display device the virtual object for which the predetermined color is set, such that the set display color is included at least in part of an image representing the virtual object.

11. The computer-readable storage medium having stored thereon the image processing program according to claim 1, wherein
the color detection means includes:
block division means for dividing the captured image into blocks each including a plurality of pixels; and
block RGB average value calculation means for calculating average values of RGB values of pixels included in each block, wherein
the color detection means detects, in the captured image, pixels corresponding to the predetermined color, on the basis of the average values of each block such that the block is a detection unit.

12. The computer-readable storage medium having stored thereon the image processing program according to claim 2, wherein
the captured image acquisition means repeatedly acquires captured images of a real world captured in real time by a real camera available to the image processing apparatus,
the color detection means repeatedly detects pixels corresponding to the predetermined color in the captured images, respectively, repeatedly acquired by the captured image acquisition means,
the object process means repeatedly performs the predetermined process on the virtual object on the basis of results of the repeated detections of the color detection means,
the image combination means repeatedly generates combined images by combining each of the captured images repeatedly acquired by the captured image acquisition means, with the image of the virtual world where the virtual object is placed, and
the image display control means repeatedly displays on the display device the combined images obtained by combining each of the captured images repeatedly acquired by the captured image acquisition means, with the image of the virtual world.

13. The computer-readable storage medium having stored thereon the image processing program according to claim 1, the image processing program further causing the computer to function as;
color setting means for, after the object process means has performed the predetermined process on the virtual object, changing the predetermined color of the virtual object to a different color.

14. The computer-readable storage medium having stored thereon the image processing program according to claim 1, the image processing program further causing the computer to function as:
process setting means for, when the color detection means has detected the pixel corresponding to the predetermined color, changing a content of the predetermined process to be performed on the virtual object for which the predetermined color is set, on the basis of the color information of the pixel.

15. An image processing apparatus that processes an image to be displayed on a display device, the image processing apparatus comprising:
captured image acquisition means for acquiring a captured image captured by a real camera;
object placement means for placing in a virtual world at least one virtual object for which a predetermined color is set;
color detection means for, in the captured image acquired by the captured image acquisition means, detecting at least one pixel corresponding to the predetermined color set for the virtual object placed in the virtual world, using color information including at least one selected from the group including RGB values, a hue, a saturation, and a brightness of each pixel of the captured image;
object process means for, when the color detection means has detected the pixel corresponding to the predetermined color, performing a predetermined process on the virtual object for which the predetermined color is set; and
image display control means for displaying on the display device an image of the virtual world where at least the virtual object is placed.

16. An image processing system, including a plurality of apparatuses configured to communicate with each other, that processes an image to be displayed on a display device, the display control system comprising:
captured image acquisition means for acquiring a captured image captured by a real camera;
object placement means for placing in a virtual world at least one virtual object for which a predetermined color is set;
color detection means for, in the captured image acquired by the captured image acquisition means, detecting at least one pixel corresponding to the predetermined color set for the virtual object placed in the virtual world, using color information including at least one selected from the group including RGB values, a hue, a saturation, and a brightness of each pixel of the captured image;
object process means for, when the color detection means has detected the pixel corresponding to the predetermined color, performing a predetermined process on the virtual object for which the predetermined color is set; and
image display control means for displaying on the display device an image of the virtual world where at least the virtual object is placed.

17. An image processing method performed by a processor or a cooperation of a plurality of processors included in an image processing system including at least one information processing apparatus capable of performing image processing for processing an image to be displayed on a display device, the image processing method comprising:
a captured image acquisition step of acquiring a captured image captured by a real camera;
an object placement step of placing in a virtual world at least one virtual object for which a predetermined color is set;
a color detection step of, in the captured image acquired in the captured image acquisition step, detecting at least one pixel corresponding to the predetermined color set for the virtual object placed in the virtual world, using color information including at least one selected from the group including RGB values, a hue, a saturation, and a brightness of each pixel of the captured image;
an object process step of, when the pixel corresponding to the predetermined color has been detected in the color detection step, performing a predetermined process on the virtual object for which the predetermined color is set; and
an image display control step of displaying on the display device an image of the virtual world where at least the virtual object is placed.
